(19) United States
(12) Patent Application Publication
(10) Pub. No.: US 2026/0267950 A1
(43) Pub. Date: Sep. 10, 2026

(54) METHODS AND APPARATUS FOR DISTRIBUTION OF MULTI-FACTOR INFORMATION AND VALIDATION THROUGH A SWITCHING NETWORK

(71) Applicant: Capital One Services, LLC, McLean, VA (US)

(72) Inventors: Kevin Osborn, Newton Highlands, MA (US); Narmeen Rahman, Brooklyn, NY (US); John Jones, Leesburg, VA (US)

(73) Assignee: Capital One Services, LLC, McLean, VA (US)

(21) Appl. No.: 19/072,252

(22) Filed: Mar. 6, 2025

(51) Int. Cl. G06F 21/32; G06Q 20/32; G06Q 20/40

(52) U.S. Cl. CPC G06F 21/32; G06Q 20/3278; G06Q 20/40145; G06F 21/31; G06Q 20/1085; G06Q 20/204; G06Q 20/401; G06Q 20/40155; G06Q 20/405; G06Q 20/4093; H04L 9/32; H04L 9/3231; H04L 9/3247

(57) ABSTRACT

Described herein are methods, systems and devices for distribution of multi-factor information in a switching network. The method includes processing a request from a computing device, the request requiring multi-factor authentication. Encrypted data from a user's contactless card is then received and validated and the encrypted data includes a unique token. Using the unique token, a biometric template for the user is gathered from a domain server in a switching network. The switching network distributes the biometric template to a server processing the request or the user's device and the user's biometric data is captured and validated using the biometric template. If the validation is successful, the user's request is granted.

### FIELD OF DISCLOSURE

The present disclosure generally relates to multi-factor authentication. More particularly, the present disclosure relates to the distribution of multi-factor authentication information and validation through a switching network.

### BACKGROUND

Contactless card products have become so universally well-known and ubiquitous that they have fundamentally changed the manner in which transactions and dealings are viewed and conducted in society today. Contactless card products are most commonly represented by plastic or metal card-like members that are offered and provided to users through card issuers (such as banks, housing companies, athletic facilities, workplaces and other institutions). With a card, an authorized user or cardholder is capable of completing transactions, gaining entry to spaces (e.g., workplace, apartment homes, gyms, etc.) without an immediate, direct exchange with another person and without having to exchange physical currency. Data security and transaction integrity are of critical importance to businesses and other institutions facilitating these transactions and entries and to the users. This need continues to grow as electronic transactions performed with contactless cards constitute an increasingly large share of commercial activity.

Multi-factor authentication has also become universally well-known and ubiquitous. Many online accounts, including banking accounts, email accounts, social media accounts, and other accounts where users login with a username and password include multi-factor authentication. In many instances, multi-factor authentication includes sending a code to the user's mobile device or email address and requesting entry of the code from the user before they can log in. Another multi-factor authentication example includes entering a personal identification number (PIN) when performing a contactless card transaction at a point-of-sale device. Yet more multi-factor authentication examples include the user being required to provide biometric information about themselves (e.g., a fingerprint scan, facial scan, an iris scan, corneal scan, a walking gait, etc.) in addition to a passcode, password, encrypted data from their contactless card, as well as other authentication methods.

Moreover, authentication networks and networks for completing transactions, as well as networks for distributing multi-factor information and validation messages are becoming more and more complex as the world continues towards automation and digitization.

There is therefore a need for additional features regarding distributing multi-factor factor (or second-factor) information throughout these complex networks that provide robust security and efficiency to process these multi-factor authentication requirements.

### BRIEF SUMMARY

In one aspect, the present disclosure describes a method for distribution of multi-factor information and validation through a switching network. In some embodiments, the method includes receiving, at a server from a mobile device, a request requiring multi-factor authentication. In some embodiments, the method further includes causing, by the server, a prompt to be displayed on the computing device for a user of the computing device to tap a contactless card to an NFC reader of the computing device, the contactless card to send encrypted data, including a unique token assigned to the contactless card, to the computing device to forward to an authentication server in communication with the server, the authentication server to validate the encrypted data. In some embodiments, the method further includes receiving, by the server, at least the unique token from the mobile device In some embodiments, the method further includes sending, by the server, a request, including the unique token, to a domain server for a security template from the domain server, the security template being associated with a user of the mobile device. In some embodiments, the method further includes receiving, by the server, a validation message from the authentication server indicating that the encrypted data is validated. In some embodiments, the method further includes receiving, by the server from the domain server, the security template. In some embodiments, the method further includes prompting, by the server, a user to provide security information to the security template. In some embodiments, the method further includes receiving, by the server, the security information. In some embodiments, the method further includes comparing, by the server, the security information to the security template, in response to the security information matching the security template. In some embodiments, the method further includes granting, by the server, the request.

In another aspect, a web server is described that comprises a processing circuit and a memory coupled to the processing circuit. In some embodiments, the memory includes executable instructions stored thereon, which when executed by the processing circuit, cause the processing circuit to perform various operations. For example, in some embodiments, the processing circuit is caused to process a request from a computing device, the request requiring multi-factor authentication. In some embodiments, the processing circuit is to cause a prompt to be displayed to a user, the prompt instructing the user of the computing device to tap a contactless card associated with the user to a near field communication (NFC) reader associated with the computing device. In some embodiments, the processing circuit is caused to receive, from the contactless card via the computing device, encrypted data from the contactless card, the encrypted data including a unique token assigned to the contactless card. In some embodiments, the processing circuit is caused to forward the encrypted data to an authentication server to validate the encrypted data. In some embodiments, the processing circuit is caused to receive an indication from the authentication server that the encrypted data is validated. In some embodiments, the processing circuit is caused to send instructions to the computing device to display a request to the user to provide biometric data. In some embodiments, the processing circuit is caused to receive the biometric data from the computing device and user and forward the biometric data along with the unique token to a domain server for the domain server to validate the biometric data. In some embodiments, the processing circuit is caused to grant the request from the computing device in response to receiving a first indication from the domain server that the biometric data is validated.

In another aspect, a switching network server is described. In some embodiments, the switching network server comprises a processing circuit and a memory having executable instructions stored thereon. When executed, the instructions cause the processing circuit to perform various operations. In some embodiments, the processing circuit is caused to receive encrypted data from a contactless card via a computing device in communication with the switching network server, where the encrypted data received from the contactless card includes a unique token assigned to the contactless card. In some embodiments, the processing circuit is caused to validate the encrypted data and send an authentication message to a transaction server indicating that the encrypted data received from the contactless card is validated. In some embodiments, the processing circuit is caused to determine, based on the unique token, a domain server from which to retrieve a biometric template corresponding to the unique token. In some embodiments, the processing circuit is caused to send a request to the domain server for the biometric template that corresponds to the unique token and receive the biometric template from the domain server. In some embodiments, the processing circuit is caused to send the biometric template to the transaction server or a biometric reader for the transaction server or the biometric reader to validate biometric data from a user associated with the contactless card and execute a transaction between the contactless card and the transaction server.

Non-transitory computer program products (e.g., physically embodied computer program products) are also described that store instructions, which, when executed by one or more data processors (e.g., processor circuit) of one or more computing systems, cause at least one data processor to perform operations herein. Similarly, computer systems are also described, which may include one or more data processors and memory coupled to the one or more data processors. The memory may temporarily or permanently store instructions that cause at least one processor to perform one or more of the operations described herein. In addition, methods can be implemented by one or more data processors, which are either within a single computing system or distributed among two or more computing systems. Such computing systems can be connected and can exchange data and/or commands or other instructions or the like via one or more connections, including but not limited to a connection over a network (e.g., the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE SEVERAL VIEWS OF THE DRAWINGS

Provided below is a brief description of the several views of the drawings which illustrate various aspects of some embodiments of the present disclosure. The various drawings are described in more detail in the Detailed Description that follows. To easily identify the discussion of any particular element or act, the most significant digit or digits in a reference number refer to the figure number in which that element is first introduced.

FIG. 1 illustrates an example system in a switching network in accordance with one embodiment.

FIG. 2 is a block diagram of an example client server in accordance with one embodiment.

FIG. 3 illustrates an example access control system in accordance with one embodiment.

FIG. 4 is a block diagram of an example switching network server in accordance with one embodiment.

FIG. 5 illustrates a contactless card in accordance with one embodiment.

FIG. 6 illustrates a transaction card component in accordance with one embodiment.

FIG. 7 is a flow diagram illustrating various operations in an example method in accordance with one embodiment.

FIG. 8 illustrates a sequence flow in accordance with one embodiment.

FIG. 9 illustrates an example of a system configured to operate in accordance with embodiments discussed herein.

FIG. 10 illustrates an aspect of the subject matter in accordance with one embodiment.

FIG. 11A illustrates an aspect of the subject matter in accordance with one embodiment.

FIG. 11B illustrates an aspect of the subject matter in accordance with one embodiment.

FIG. 11C illustrates an aspect of the subject matter in accordance with one embodiment.

FIG. 12 illustrates an aspect of the subject matter in accordance with one embodiment.

FIG. 13 is a flow chart illustrating various operations of an example method in accordance with one embodiment.

FIG. 14 illustrates an aspect of the subject matter in accordance with one embodiment.

FIG. 15 illustrates an aspect of the subject matter in accordance with one embodiment.

FIG. 16 is a flow diagram illustrating various operations in an example method in accordance with one embodiment.

FIG. 17A is a flow diagram illustrating various operations in an example method in accordance with one embodiment.

FIG. 17B is a flow diagram illustrating various operations in an example method in accordance with one embodiment.

### DETAILED DESCRIPTION

Described herein are techniques, systems, apparatuses, and methods for distribution of multi-factor information and validation through a switching network. The techniques described herein may be used for distribution of multi-factor information related to a user attempting to log in to a website or account, establish a service, such as a virtual private network (VPN) service, complete a transaction, or perform some other function where multi-factor authentication may be desired. The multi-factor information can include biometric information or other information such as a personal identification number (PIN) or other multi-factor data. In some cases, a multi-factor authentication can be performed. Namely, a user can enter their username and password, as a first factor, tap their contactless card and transmit encrypted data (as described below), as a multi-factor, and as a third factor, provide the biometric data, a PIN, or other data to complete authentication. In some other scenarios, only the contactless card tap and the biometric data or PIN are used to authenticate one of the transactions or logins above. In some other embodiments, any combination of authentication factors (e.g., username and password, PIN, biometric data, and contactless card tap) can be used to log in to an account, utilize a service (e.g., VPN service), access a physical space, or access a website.

In some embodiments, the web server, transaction server, VPN server, or any other device that the user is attempting to use, access, or log in to, (also referred to herein as a client server) will establish a session with a switching network server and request multi-factor authentication with the switching network server. Again, the first factor will be login credentials, the use of the contactless card, or other first factor authentication data. The client server will request the switching network server to provide multi-factor authentication for the event, and the client server will select the type of authentication for a second factor, as well as a biometric domain if a biometric authentication type is selected. As referred to herein, the biometric domain is the domain, area, or function, for which a given biometric verification is registered. The biometric domain can be centralized by a controller, server, or area access system (e.g., building access system). In the first instance, the biometric template is verified against other forms of ID, and can thereafter be used as a primary authentication factor, because central trust has been established by the system. In the second instance, it is usually only used as a second factor, once the owner of the device has logged into some service and established ownership of the device, because the registration of the biometric template isn't verified by the controller of the application's authorization domain. The client server will select the type of second factor authentication based on user input or based on a predetermined type for the particular client server.

After the user has attempted to login or otherwise access or use the client server, the user verifies their identity by sending encrypted data with their contactless card and second factor information, including the type of second factor information, is requested by the client server. The client server then communicates with the switching network server to gather a biometric template, or other second factor authentication information, from the domain server according to the type of second factor information selected (e.g., biometric data, a PIN, etc.). The domain server accesses the biometric template for the user associated with the contactless card and the biometric comparison and authentication is either performed on the domain server or locally by the client server or the mobile device used by the user. If performed on the domain server a message is sent to the user to provide the biometric data to the domain server (e.g., scanning their fingerprint or face on their mobile device, or provide biometric data to the domain server with some other device in communication with the domain server). Alternatively, if the biometric authentication is performed locally, the biometric template is sent from the domain server to the client server or the mobile device of the user so the local device can compare the user's biometric data to the biometric template. Again, instead of a biometric template and biometric data, a PIN or other passcode can be used.

Once the biometric or other data is authenticated, the transaction is permitted, the user is logged into the website, the user is given VPN access, the user is granted access to a physical space, or some other action occurs based on the functions of the client server. Moreover, an access function is called by the switching network server, and a validation token is stored on the client server to indicate that the user's biometric data has been authenticated recently and does not need to be checked again for a predetermined period of time. This new authentication claim is stored on the client server and the switching network server.

The following description of exemplary embodiments provides non-limiting representative examples referencing numerals to particularly describe features and teachings of different aspects of the invention. The embodiments described should be recognized as capable of implementation separately, or in combination, with other embodiments from the description of the embodiments. A person of ordinary skill in the art reviewing the description of embodiments should be able to learn and understand the different described aspects of the invention. The description of embodiments should facilitate understanding of the invention to such an extent that other implementations, not specifically covered but within the knowledge of a person of skill in the art having read the description of embodiments, would be understood to be consistent with an application of the invention.

Furthermore, the described features, advantages, and characteristics of the exemplary embodiments may be combined in any suitable manner. One skilled in the relevant art will recognize that the embodiments may be practiced without one or more of the specific features or advantages of an embodiment. In other instances, additional features and advantages may be recognized in certain embodiments that may not be present in all embodiments. One skilled in the relevant art will understand that the described features, advantages, and characteristics of any embodiment can be interchangeably combined with the features, advantages, and characteristics of any other embodiment.

The systems discussed here may enable users to perform these functions in a multi-issuer environment. Further, the systems discussed herein enable card issuers or payment providers, such as banks, to issue contactless cards with tap-to functions to customers while maintaining high-level security. The systems and methods discussed differ from previous solutions because they provide a single platform for multiple issuers to provide the tap-to functionality. Traditionally, each issuer must set up and maintain its own systems to provide contactless card features. This includes maintaining their own hardware, software, databases, security protocols, and so forth, which can become extremely costly for the issuer to maintain. However, the embodiments discussed enable issuers to offload much of the processing, storage, and security functionality to a neutral or central system. As will be discussed in more detail, the central system is configured to provide contactless card features for multiple issuers while maintaining high security and data integrity. Each issuer's functionality and data may be separately managed and secured such that another issuer cannot access another issuer's data or functions. As will be discussed in more detail, these features may be provided by a switchboard system configured to process and perform each contactless card function securely. Additional benefits for issuers may include providing a highly secure authentication option for mobile web, which typically lacks the robust authentication options available in a native application.

Further, embodiments discussed herein support tap-to mobile web experiences on both major mobile platforms (iOS®, Android®) by leveraging App Clips® and Javascript® SDK with WebNFC®. For iOS®, embodiments include providing a tap-to software development kit including functions and services to perform the operations discussed herein on the iOS® platform. The SDK may be installed into the host application, e.g., a native app or web browser app, and includes App Clip® support. The SDK provides functional support for near-field communication between the mobile device and contactless card, installing a native app via App Clips®, and functionality to obscure data and/or portions of a display. In one example, the SDK may be configured to download and install the app from an app store, such as Apple's® App Store.

In the Android® operating system environment, embodiments include utilizing a JavaScript SDK. The JavaScript SDK may be installed into a website e.g., via source code. The JavaScript SDK also includes functions to support NFC communications between mobile devices and contactless cards via WebNFC®. The JavaScript SDK may also include functions to provide customizable user interface (UI) capabilities and obfuscation. In embodiments, the JavaScript SDK supports websites utilizing Hypertext Transfer Protocol Secure (HTTPS) and supports the React® library. Embodiments are not limited in this manner, and UI libraries may be supported.

With general reference to notations and nomenclature used herein, one or more portions of the detailed description which follows may be presented in terms of program procedures executed on a computer or network of computers. These procedural descriptions and representations are used by those skilled in the art to most effectively convey the substances of their work to others skilled in the art. A procedure is here, and generally, conceived to be a self-consistent sequence of operations leading to a desired result. These operations are those requiring physical manipulations of physical quantities. Usually, though not necessarily, these quantities take the form of electrical, magnetic, or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, these manipulations are often referred to in terms, such as adding or comparing, which are commonly associated with mental operations performed by a human operator. However, no such capability of a human operator is necessary, or desirable in most cases, in any of the operations described herein that form part of one or more embodiments. Rather, these operations are machine operations. Useful machines for performing operations of various embodiments include digital computers as selectively activated or configured by a computer program stored within that is written in accordance with the teachings herein, and/or include apparatus specially constructed for the required purpose or a digital computer. Various embodiments also relate to apparatus or systems for performing these operations. These apparatuses may be specially constructed for the required purpose. The required structure for a variety of these machines will be apparent from the description given.

Reference is now made to the drawings, wherein like reference numerals are used to refer to like elements throughout. In the following description, for the purpose of explanation, numerous specific details are set forth in order to provide a thorough understanding thereof. It may be evident, however, that the novel embodiments can be practiced without these specific details. In other instances, well-known structures and devices are shown in block diagram form in order to facilitate a description thereof. The intention is to cover all modification, equivalents, and alternatives within the scope of the claims.

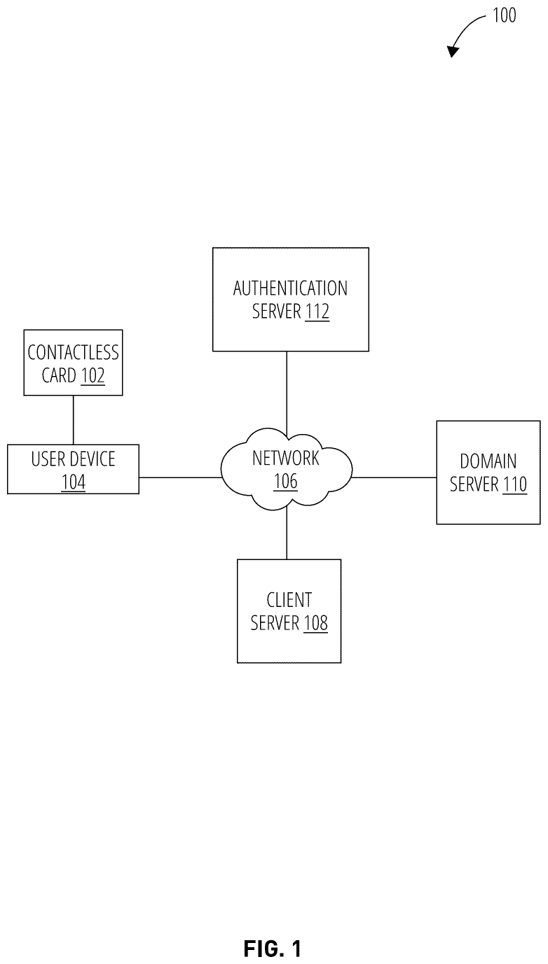

FIG. 1 illustrates a data transmission system 100 according to an example embodiment. As further discussed below, system 100 may include contactless card 102, user device 104, network 106, client server 108, domain server 110, and authentication server 112. Although FIG. 1 illustrates single instances of the components, system 100 may include any number of components.

System 100 may include one or more contactless cards 102, which are further explained below. In some embodiments, contactless card 102 may be in wireless communication, utilizing NFC in an example, with user device 104.

System 100 may include user device 104, which may be a network-enabled computer. As referred to herein, a network-enabled computer may include, but is not limited to a computer device, or communications device including, e.g., a server, a network appliance, a personal computer, a workstation, a phone, a handheld PC, a personal digital assistant, a thin client, a fat client, an Internet browser, or other device. User device 104 also may be a mobile device; for example, a mobile device may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

The user device 104 device can include a processor and a memory, and it is understood that the processing circuitry may contain additional components, including processors, memories, error and parity/CRC checkers, data encoders, anticollision algorithms, controllers, command decoders, security primitives and tamperproofing hardware, as necessary to perform the functions described herein. The user device 104 may further include a display and input devices. The display may be any type of device for presenting visual information such as a computer monitor, a flat panel display, and a mobile device screen, including liquid crystal displays, light-emitting diode displays, plasma panels, and cathode ray tube displays. The input devices may include any device for entering information into the user's device that is available and supported by the user's device, such as a touch-screen, keyboard, mouse, cursor-control device, touch-screen, microphone, digital camera, video recorder or camcorder. These devices may be used to enter information and interact with the software and other devices described herein.

In some examples, user device 104 of system 100 may execute one or more applications, such as software applications, that enable, for example, network communications with one or more components of system 100 and transmit and/or receive data.

The user device 104 may be in communication with one or more server(s), such as client server 108, domain server 110, or authentication server 112, via one or more network(s) 106, and may operate as a respective front-end to back-end pair with client server 108. The user device 104 may transmit, for example from an application executing on user device 104, one or more requests to client server 108, including requests for data, requests for logging into an account, or requests to perform some function described herein. The one or more requests may be associated with retrieving data from client server 108 or sending instructions to the client server 108 to perform some other function (e.g., controlling a door or lock to allow access to a physical space).

System 100 may include one or more networks 106 to facilitate communication, as described herein, between the user device 104, client server 108, domain server 110, and authentication server 112. In some examples, network 106 may be one or more of a wireless network, a wired network or any combination of wireless network and wired network, and may be configured to connect user device 104 to client server 108. For example, network 106 may include one or more of a fiber optics network, a passive optical network, a cable network, an Internet network, a satellite network, a wireless local area network (LAN), a Global System for Mobile Communication, a Personal Communication Service, a Personal Area Network, Wireless Application Protocol, Multimedia Messaging Service, Enhanced Messaging Service, Short Message Service, Time Division Multiplexing based systems, Code Division Multiple Access based systems, D-AMPS, Wi-Fi, Fixed Wireless Data, IEEE 802.11 family of networking, Bluetooth, NFC, Radio Frequency Identification (RFID), Wi-Fi, and/or the like.

In addition, network 106 may include, without limitation, telephone lines, fiber optics, IEEE Ethernet 802.3, a wide area network, a wireless personal area network, a LAN, or a global network such as the Internet. In addition, network 106 may support an Internet network, a wireless communication network, a cellular network, or the like, or any combination thereof. network 106 may further include one network, or any number of the exemplary types of networks mentioned above, operating as a stand-alone network or in cooperation with each other. network 106 may utilize one or more protocols of one or more network elements to which they are communicatively coupled. network 106 may translate to or from other protocols to one or more protocols of network devices. Although network 106 is depicted as a single network, it should be appreciated that according to one or more examples, network 106 may comprise a plurality of interconnected networks, such as, for example, the Internet, a service provider's network, a cable television network, corporate networks, such as credit card association networks, and home networks.

System 100 may include one or more client servers 108. The client server 108 may be connected to at least one user device 104 via the network 106. In some examples, client server 108 may include one or more processors, which are coupled to memory. The client server 108 may be configured as a central system, server or platform to perform various operations. For example, client server 108 may be configured to connect to the one or more databases to gather requested data. In some embodiments, the user device 104 can request to log in to a user account associated with a website executed on the client server 108 (e.g., the client server 108 can be a web server or application server). In some embodiments, the user can attempt to establish a VPN and the client server 108 can be a VPN server. In some embodiments, the client server 108 can be a transaction server, and the request can be a request to execute a transaction. In some embodiments, the client server 108 can be a access controller, controlling access to a physical space (e.g., storage locker, physical room, building, apartment door, etc.). In some embodiments, the client server 108 can be a banking server, and the user device 104 can request access to a banking application or website associated with the banking server. In some embodiments, the client server 108 can perform multiple functions described above. For example, the client server 108 can be both a web server and an application server, or the client server 108 can be both a web server and an access controller.

The client server 108 may receive the one or more requests from user device 104. Based on the one or more requests from user device 104, client server 108 may be configured to provide requested data or perform some other function described herein. In some other embodiments, the client server 108 can establish a VPN, send a control signal to an electronic lock or door mechanism to unlock a locker, door, or otherwise provide access to a physical space. In some other embodiments, the client server 108 can provide access to a user account such as the banking account described above. The client server 108 could further provide access to a user account to a website, provide access to the website, approve (or otherwise execute) a transaction, or respond to the request in any appropriate way based on the configured functions of the client server 108.

In some embodiments, the system 100 includes a domain server 110. The domain server 110 comprises a processing circuit and memory and may also include a database of biometric templates associated with unique tokens assigned to contactless cards of users. For example, the domain server 110 will include a database and the database will have an entry for one or more unique tokens, each associated with or assigned to a contactless card of a user. Each unique token in the database will have a one or more entries including one or more biometric templates associated with each unique token. In addition, each database entry for the unique token can include a PIN or other code.

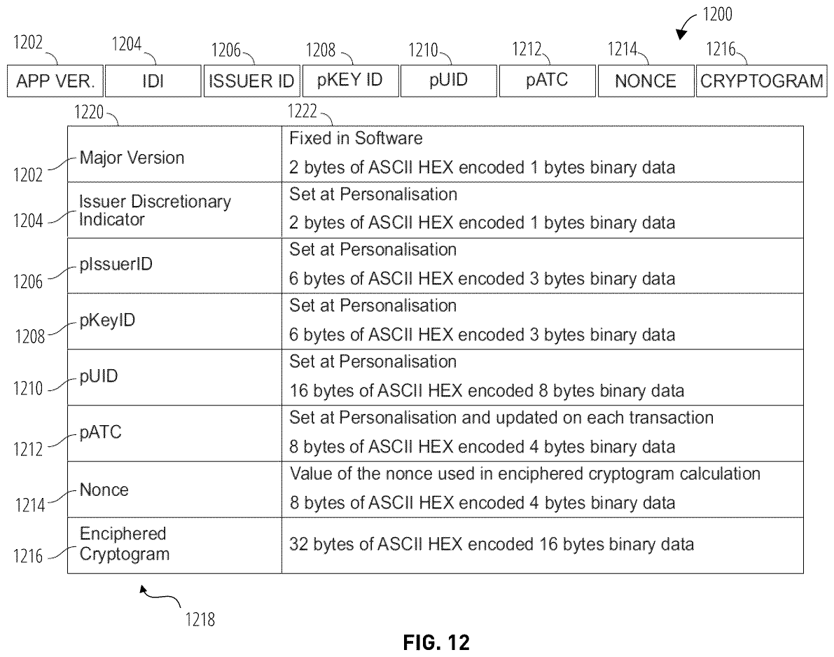

The unique token can be any alphanumeric token that is unique to, and identifies, the specific contactless card 102. For example, the unique token can include the pUID 1210 described below with respect to FIG. 12.

In some embodiments, the domain server 110 is configured to receive a request from the client server 108 for the biometric template, PIN, or other code, or to receive a request to validate received biometric data, a PIN, or other code received from the user device 104. For example, as discussed herein, the domain server 110 may receive a request to send the biometric template or PIN to the client server 108 which can perform a biometric validation locally, or the domain server 110 will receive the biometric data or PIN from the user device 104, and the biometric or PIN validation is performed by the domain server 110.

In some embodiments, the system 100 includes an authentication server 112. The authentication server 112 is configured to receive encrypted data from the contactless card 102 after the contactless card 102 is tapped to an NFC reader (or other device for receiving the encrypted data from the contactless card 102), such as the user device 104. The contactless card 102 being tapped to the NFC reader, such as the user device 104, may act as a first or second factor during an authentication procedure. The encrypted data will be sent to the authentication server 112 to be decrypted and validated as described herein.

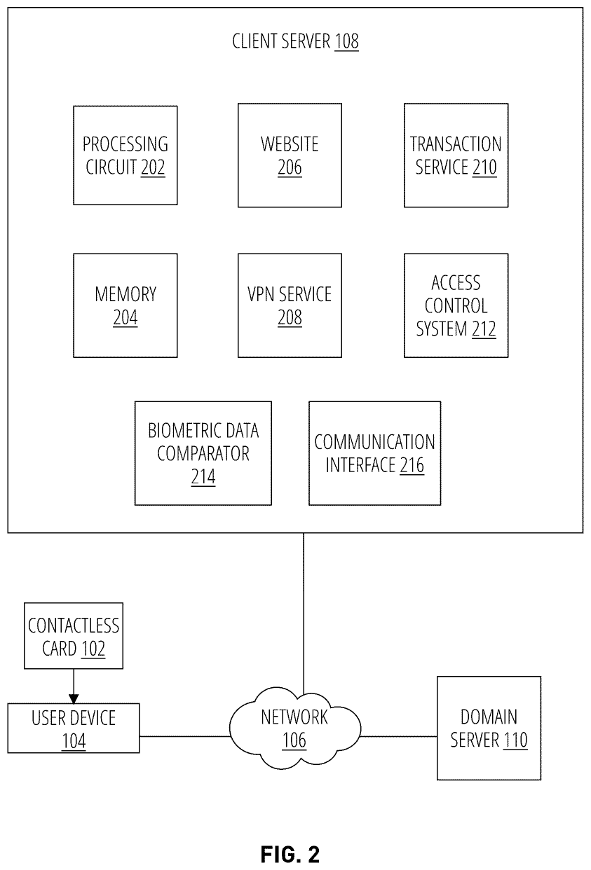

FIG. 2 includes a block diagram of the client server 108 according to some embodiments of the present disclosure. In some embodiments, the client server 108 includes a processing circuit 202 and a memory 204 coupled to the processing circuit 202. The memory 204 has executable instructions stored thereon, which when executed by the processing circuit 202, cause the processing circuit 202 to perform various operations described herein. In some embodiments, the client server 108 operates as a web server and executes or manages a website 206 (e.g., social media website, email website, merchant website, or any other suitable website where a user may need to log into an account on the website to gain access thereto). In some other embodiments, the client server 108 operates as a VPN server, and executes or maintains a VPN Service 208. In some embodiments, the client server 108 operates as a transaction server to execute or approve transactions and includes a transaction service 210. In some other embodiments, the client server 108 operates as an access controller and includes an access control system 212 for controlling access to a physical space. In some embodiments, the client server 108 acts as an application server or banking server, and maintains a banking application or other application (not shown) operating thereon.

As described herein, some requests to the client server 108 may require multi-factor authentication to access services thereof or to cause the client server 108 to perform various functions. In such cases, the user may log in or otherwise try to access or utilize the services or functions of the client server 108 and the processing circuit 202 will receive and process a request from a computing device, such as user device 104 to log in to the client server 108 or other wise utilize the functions of the client server 108. After the request is processed, the processing circuit 202 is to cause a prompt to be displayed to a user, the prompt instructing the user of the computing device to tap a contactless card 102 associated with the user to a near field communication (NFC) reader associated with the computing device. For example, the user can attempt to access or otherwise utilize the functions of the client server 108 via the user device 104. Upon communicating with the client server 108, the user device 104 can display the prompt on its own display, or cause another display in communication with the user device 104 to display the prompt.

The NFC reader can be integrated with the computing device or user device 104 itself (e.g., an NFC antenna integrated on a mobile device), or the user device 104 can include an NFC reader attached thereto that allows the user device 104 to communicate with the contactless card 102 via NFC. The processing circuit 202 is caused to receive, from the contactless card 102 via the computing device, encrypted data from the contactless card 102. In some embodiments, the encrypted data includes a unique token assigned to the contactless card 102. The unique token can be used later by the domain server 110 to identify the biometric template or PIN described herein.

Once the encrypted data (which includes the unique token) is obtained by the client server 108 from the user device 104 reading the contactless card 102, the encrypted data is forwarded to the authentication server 112 for validation. Once the authentication server 112 has validated the encrypted data, the processing circuit 202 is caused to receive an indication from the authentication server 112 that the encrypted data is validated. This is the first or second factor authentication depending on if the user signed in with a password. A second or third form of authentication is then triggered, including validation of biometric data of the user or a PIN. The biometric data or other security data may be referred to as security information. In some embodiments, validation of the biometric data or PIN is performed locally on the client server 108 or the user device 104. In other embodiments, the validation of the biometric data or PIN is performed by the client server 108 sending the unique token and the biometric data from the user to the domain server 110 for validation.

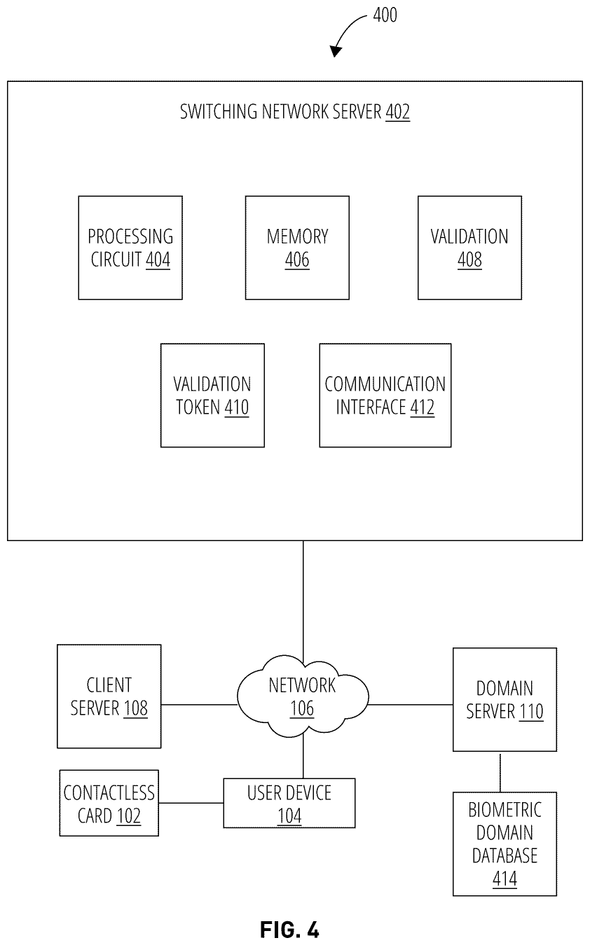

In the embodiment where the validation of the biometric data or PIN is performed locally on the client server 108 or the user device 104, the processing circuit 202 is configured to extract the unique token from the encrypted data from the contactless card 102. The user may indicate on the user device 104 which type of biometric validation they want to use for their next factor authentication. Alternatively, the type of biometric validation is already selected or determined by the client server 108. The unique token and the type of biometric validation are sent to the domain server 110 (e.g., via the switching network server 402 shown in FIG. 4) and the domain server 110 is to query a database for a biometric template for the user corresponding to the biometric validation type. For example, the user can select fingerprint validation, facial recognition validation, walking gait recognition, or any other type of biometric data. Alternatively, the type of biometric validation can be pre-selected or predetermined for the client server 108. The biometric template can include expected fingerprint data, facial features data, retina or cornea data, a walking gait of the user, or any other suitable expected biometric data associated with the user. Alternatively, instead of a biometric validation type, the user can select to validate using a PIN. The domain server 110 will then query a separate database the PIN associated with the contactless card 102 and the user. The domain server 110 can then send the biometric template or the PIN to the client server 108 or user device 104 for local validation.

In some embodiments, the processing circuit 202 is caused to send instructions to the computing device (e.g. user device 104) to display a request to the user to provide biometric data. In some embodiments, the instructions to the display the request to the user to provide the biometric data includes a type or types of biometric data to be provided by the user. This may include any of the types of biometric data described above. The user device 104 includes a fingerprint scanner, camera, or other hardware capable of capturing the appropriate biometric data. In some embodiments, where the validation of the biometric data occurs on the user device 104 and the user device 104 received the biometric template or PIN, the biometric data is captured by the user device 104, and the biometric data is compared to the biometric template. If the biometric data matches the biometric template (or corresponds to the biometric template within a certain degree of similarity), the biometric data is validated and the user device 104 sends a message to the client server 108 indicating the validation. Alternatively, the biometric template is sent to the client server 108 and the user device 104 is configured to send the captured biometric data of the user and send it to the client server 108 for validation with the biometric template.

For example, the client server 108 can use the biometric data comparator 214 to compare the captured biometric data from the user device 104 and compare it to the biometric template. If the biometric data is similar to the data in the biometric template within a predefined degree of similarity, the biometric data is validated.

In the alternative embodiment where the domain server 110 performs the biometric validation, the user device 104 is configured to capture the biometric data and send the data to the client server 108. The processing circuit 202 of the client server 108 is then caused to receive the biometric data from the computing device (e.g., user device 104) and user, and forward the biometric data along with the unique token to the domain server 110 for the domain server 110 to validate the biometric data. In some embodiments, the processing circuit 202 being caused to forward the biometric data along with the unique token to the domain server 110 includes the processing circuit 202 being configured to send the biometric data along with the unique token to a switching network server (e.g., switching network server 402 shown in FIG. 4) to determine the domain server 110 to which the biometric data and the unique token are to be sent. For example, there may be a plurality of domain servers 110, and the switching network server 402 is configured to determine which of the plurality of domain servers 110 has the biometric template for the unique token.

In either case, whether the biometric data is validated on the user device 104, the client server 108, or the domain server 110, once the validation is performed and the biometric data is validated over the biometric template, the processing circuit 202 is caused to grant the request from the computing device. If the domain server 110 performs the validation, then the client server 108 is caused to grant the request from the computing user device 104 in response to receiving a first indication from the domain server 110 that the biometric data is validated. Similarly, the user device 104 can send an indication that the biometric data is validated in order to trigger the client server 108 to grant the user request from the user of the user device 104.

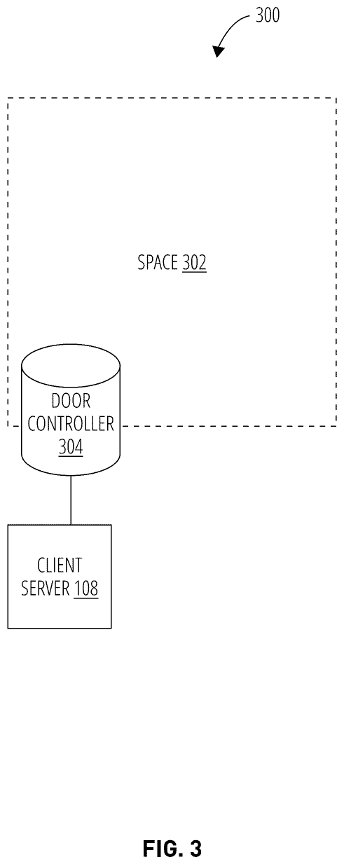

In some embodiments, granting the user request comprises granting the user login access to an account or website 206. In some other embodiments, granting the user request includes granting a transaction request via transaction service 210 or granting the user access to a banking account, social media account or other account. In some other embodiments, granting the request includes granting the user access to a physical space by engaging access control system 212 (described in further detail in FIG. 3). In some other embodiments, granting the request includes establishing a VPN connection via the VPN Service 208.

In some embodiments, the client server 108 is configured to communicate with any of the devices described herein, including the user device 104 and domain server 110 via communication interface 216 which can include any wired or wireless interface suitable for allowing the client server 108 to participate in communications therewith.

In some embodiments where the biometric data is not validated, the processing circuit 202 is further caused to deny the request from the computing device in response to receiving a second indication from the domain server 110 that the biometric data is not validated. The denial of the request also occurs if the client server 108 or the user device 104 determines that the biometric data captured from the user does not match the biometric template within a predetermined degree of similarity. In some embodiments, the processing circuit 202 is further caused to receive a validation token from the switching network server 402 validating that the biometric data matches the biometric template corresponding to the unique token, the validation token to be stored in the memory 204 for a predetermined period of time.

For example, the validation token can be configured to expire and be deleted from the memory 204 after 24 hours or some other predetermined period of time. The validation token is alternatively stored on the switching network server 402 shown in FIG. 4, in embodiments where the domain server 110 performs the validation of the biometric data. Although the above description focuses on validation of biometric data using a biometric template, similar functions can be called and performed to validate a PIN (e.g., compare received PIN to expected PIN in the domain server 110) or other suitable code.

FIG. 3 illustrates an example access control environment 300 comprising a physical space 302 such as a smart locker, a room with a door, an apartment room or building, a gym, a garage, or any other suitable space 302. The physical space 302 has a door to access the space 302. The door is controlled to be opened or unlocked by a door controller 304. The door controller 304 can include an electronic smart lock that is network connected to the client server 108 (e.g., network connected to access control system 212 via network 106), an actuator, or any other suitable device to unlock or otherwise open the door to allow access to the space 302.

In some embodiments, when the multi-factor authentication scenario described herein is validated, including the biometric data validated as described above in FIG. 2, the client server 108 can be configured to send a control signal to the door controller 304 to actuate and allow the door to be opened to allow access to the space 302. For example, the space 302 can be embodied as a smart locker and a control signal is sent by the client server 108 to the door controller 304 such that the locker door is unlocked or actuated to automatically open. Alternatively, the access control environment 300 includes a locked room or other physical space 302, and the control signal is sent to the door controller 304 to unlock the door to the room or other physical space 302. The control signal can also be sent to lock the door as well.

FIG. 4 illustrates a transaction environment 400, and demonstrates one example of a transaction occurring between the user device 104 and the client server 108. For example, the user device 104 may be used to initiate a transaction with the client server 108, which can act as a transaction server (e.g., a server that facilitates, approves, or denies a transaction). In this example embodiment, the user attempts to complete the transaction by paying for goods or services by tapping the contactless card 102 to the user device 104. Before the transaction can be completed, the client server 108 may require multi-factor authentication to verify the transaction. For example, a first factor can be the encrypted data sent by the contactless card 102 when it is tapped, as described herein, and a second factor can be the exchange of biometric data or a PIN as described herein.

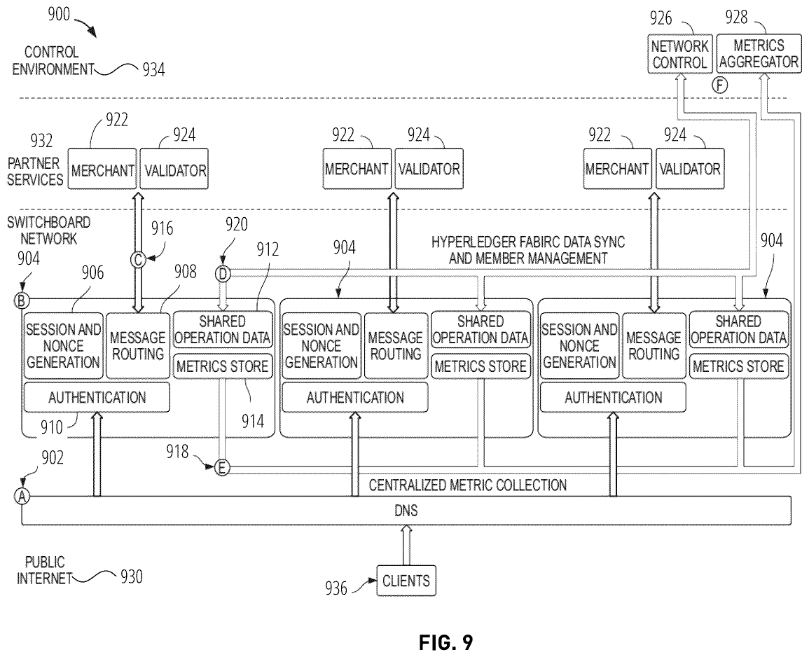

FIG. 4 includes a block diagram of an example switching network server 402 according to some embodiments of the present disclosure. In some embodiments, the switching network server 402 can be the node 904 from the switchboard system 900 from FIG. 9. The switchboard system 900 is a switching network used to distribute encrypted data from the contactless card 102 to an authentication server, such as node 904, which performs validation of the encrypted data from the contactless card 102. The switching network server 402 can also be the authentication server 112 from FIG. 1 above.

The switching network server 402, can be used to handle the encrypted data from the contactless card 102 and perform validation thereof, but also communicate with the domain server 110 to perform biometric data and PIN validation as well. In some embodiments, the switching network server 402 includes a processing circuit 404 and a memory 406 coupled to the processing circuit 404. The memory 406 may have executable instructions stored thereon, which when executed may cause the processing circuit 404 to perform various operations described herein.

For example, in some embodiments, the processing circuit 404 is caused to receive encrypted data from a contactless card, such as contactless card 102 from FIG. 1, via a computing device, such as user device 104, in communication with the switching network server 402. In some embodiments, the encrypted data received from the contactless card 102 includes a unique token assigned to the contactless card 102. The unique token is the same unique token described above, that can be used by the domain server 110 to query the database to identify the biometric template.

In some embodiments, once the switching network server 402 has received the encrypted data from the contactless card 102, the processing circuit 404 is caused to validate the encrypted data and send an authentication message to a transaction server (e.g., client server 108) indicating that the encrypted data received from the contactless card 102 is validated. The encrypted data from the contactless card 102 can be decrypted by the switching network server 402 using a shared key commonly known between the contactless card 102 and the switching network server 402. Once the encrypted data is decrypted, the switching network server 402 can compare expected data for the contactless card 102 with the decrypted data, and if the decrypted data corresponds to the expected data, the encrypted data is validated. A message can then be sent from the switching network server 402 to the client server 108 indicating that the encrypted data has been validated. As described above, this may be the first factor of authentication for the transaction between the user device 104 and the client server 108.

In some embodiments, the processing circuit 404 is caused to extract the unique token from the encrypted data from the contactless card 102, and determine, based on the unique token, a domain server, e.g. domain server 110, from which to retrieve a biometric template corresponding to the unique token. For example, there may be a plurality of domain servers and the switching network server 402 will need to determine which of the plurality of domain servers 110 to contact to obtain the biometric template from. Alternatively, the switching network server 402 will need to determine which domain server 110 to send the biometric data from the user device 104 to in order to perform the biometric validation. Once the domain server 110 is determined, the processing circuit 404 is caused to send a request to the domain server 110 for the biometric template that corresponds to the unique token and receive the biometric template from the domain server 110. For example, the domain server 110 will receive the request, that includes the unique token, and query a biometric domain database 414 to find the biometric template that corresponds to the unique token. The domain server 110 then sends the biometric template to the switching network server 402.

In some embodiments, for example, during a local validation of the biometric data on the user device 104 or the client server 108, the processing circuit 404 of the switching network server 402 is caused to send the biometric template to the transaction server (e.g., client server 108) or a biometric reader for the transaction server or the biometric reader to validate biometric data from a user associated with the contactless card 102 and execute a transaction between the contactless card 102 and the client server 108, which is acting as a transaction server. That is, in some embodiments, the biometric template can be sent to the client server 108 or the user device 104, and the user device 104 collects the biometric data from the user, as described above, and the collected biometric data is then compared to the biometric template on the user device 104 or the client server 108. If the biometric data corresponds to the biometric template within a predetermined amount of similarity, as described above, the client server 108 is configured to approve the transaction between the client server 108 and the user device 104.

In embodiments where the biometric data is to be sent to the domain server 110 for validation, the domain server 110 sends a message to the switching network server 402 indicating that biometric data is needed from the user, and the switching network server 402 communicates with the client server 108 or the user device 104 requesting the biometric data. The biometric data of the user is captured by the user device 104, and then forwarded to the switching network server 402, which then sends the biometric data to the domain server 110, which then performs the biometric validation. If the validation is successful, the domain server 110 sends a message to the switching network server 402 indicating that the validation is successful. The switching network server 402 then sends a message to the client server 108 indicating that the validation is successful and the transaction is approved by the client server 108.

In some embodiments, the processing circuit 404 is further configured to generate a validation token associated with the contactless card 102 indicating that the client server 108 has validated the biometric data from the user based on the biometric template. In some embodiments, the validation token indicates that the biometric data from the user has been validated recently within a predetermine period of time. In some embodiments, the processing circuit 404 is further configured to send the validation token to the client server 108 for the client server 108 to store in a memory thereof. In this example, the client server 108 is not required to validate the user's biometric data again until after a second predetermined period of time since the validation token was generated.

In some embodiments, the biometric template includes data representing an expected series of biometric data to be received from the user, the biometric data including data related to biometric features of the user including at least one of facial features, ocular features (e.g., retina, cornea, iris), hand or finger features, voice features, and gait features of the user.

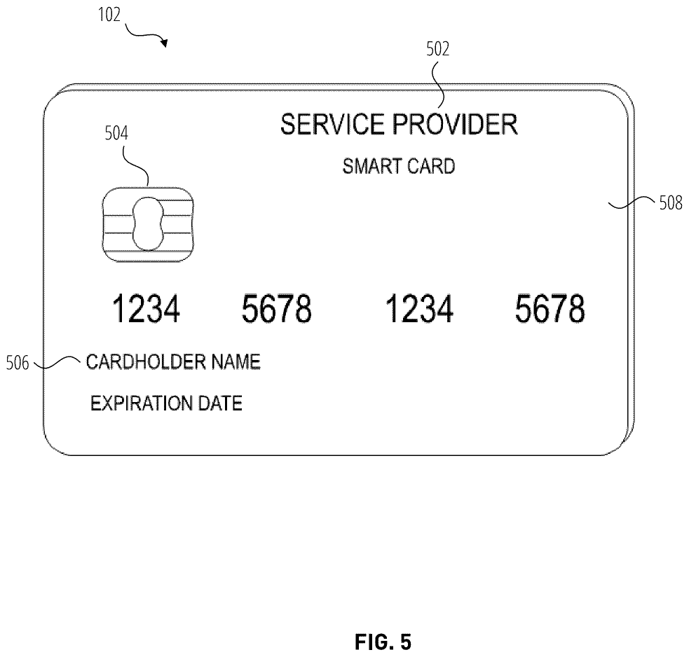

FIG. 5 illustrates an example configuration of a contactless card 102 according to some embodiments herein, which may include a contactless card, a payment card, such as a credit card, debit card, or gift card, issued by a service provider as displayed as service provider indicia 502 on the front or back of the contactless card 102. In some examples, the contactless card 102 is not related to a payment card, and may include, without limitation, an identification card. In some examples, the transaction card may include a dual interface contactless payment card, a rewards card, and so forth. The contactless card 102 may include a substrate 508, which may include a single layer or one or more laminated layers composed of plastics, metals, and other materials. Exemplary substrate materials include polyvinyl chloride, polyvinyl chloride acetate, acrylonitrile butadiene styrene, polycarbonate, polyesters, anodized titanium, palladium, gold, carbon, paper, and biodegradable materials. In some examples, the contactless card 102 may have physical characteristics compliant with the ID-1 format of the ISO/IEC 7816 standard, and the transaction card may otherwise be compliant with the ISO/IEC 14443 standard. However, it is understood that the contactless card 102 according to the present disclosure may have different characteristics, and the present disclosure does not require a transaction card to be implemented in a payment card.

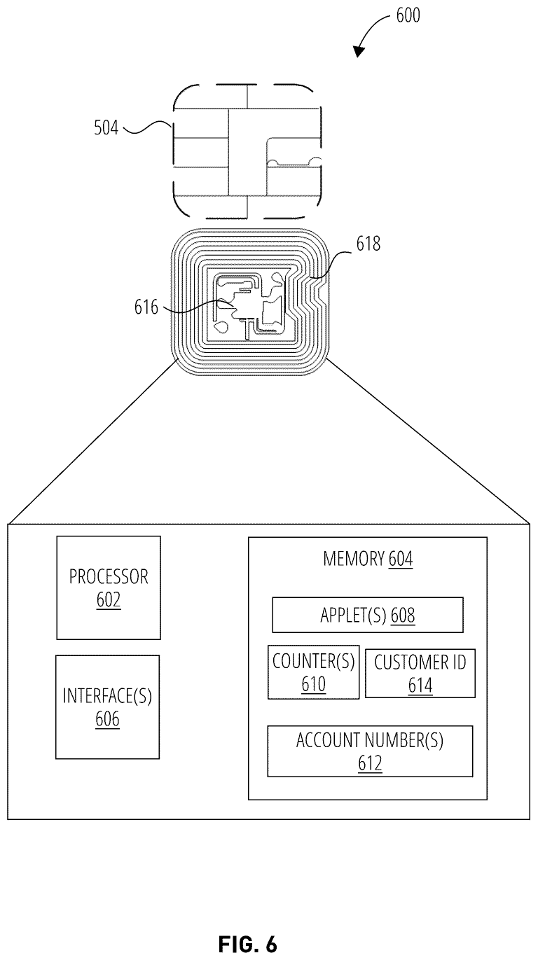

The contactless card 102 may also include identification information 506 displayed on the front and/or back of the card, and a contact pad 504. The contact pad 504 may include one or more pads and be configured to establish contact with another client device, such as an ATM, a user device, smartphone, laptop, desktop, or tablet computer via transaction cards. The contact pad may be designed in accordance with one or more standards, such as ISO/IEC 7816 standard, and enable communication in accordance with the EMV protocol. The contactless card 102 may also include processing circuitry, antenna and other components as will be further discussed in FIG. 6. These components may be located behind the contact pad 504 or elsewhere on the substrate 508, e.g. within a different layer of the substrate 508, and may electrically and physically coupled with the contact pad 504. The contactless card 102 may also include a magnetic strip or tape, which may be located on the back of the card (not shown in FIG. 5). The contactless card 102 may also include a Near-Field Communication (NFC) device coupled with an antenna capable of communicating via the NFC protocol. Embodiments are not limited in this manner.

As illustrated in FIG. 5, the contact pad 504 of contactless card 102 may include processing circuitry 616 for storing, processing, and communicating information, including a processor 602, a memory 604, and one or more interface(s) 606. It is understood that the processing circuitry 616 may contain additional components, including processors, memories, error and parity/CRC checkers, data encoders, anticollision algorithms, controllers, command decoders, security primitives and tamperproofing hardware, as necessary to perform the functions described herein.

The memory 604 may be a read-only memory, write-once read-multiple memory or read/write memory, e.g., RAM, ROM, and EEPROM, and the contactless card 102 may include one or more of these memories. A read-only memory may be factory programmable as read-only or one-time programmable. One-time programmability provides the opportunity to write once then read many times. A write once/read-multiple memory may be programmed at a point in time after the memory chip has left the factory. Once the memory is programmed, it may not be rewritten, but it may be read many times. A read/write memory may be programmed and re-programed many times after leaving the factory. A read/write memory may also be read many times after leaving the factory. In some instances, the memory 604 may be encrypted memory utilizing an encryption algorithm executed by the processor 602 to encrypted data.

The memory 604 may be configured to store one or more applet(s) 608, one or more counter(s) 610, a customer identifier 614, and the account number(s) 612, which may be virtual account numbers. The one or more applet(s) 608 may comprise one or more software applications configured to execute on one or more contactless cards, such as a Java® Card applet. However, it is understood that applet(s) 608 are not limited to Java Card applets, and instead may be any software application operable on contactless cards or other devices having limited memory. The one or more counter(s) 610 may comprise a numeric counter sufficient to store an integer. The customer identifier 614 may comprise a unique alphanumeric identifier assigned to a user of the contactless card 102, and the identifier may distinguish the user of the contactless card from other contactless card users. In some examples, the customer identifier 614 may identify both a customer and an account assigned to that customer and may further identify the contactless card 102 associated with the customer's account. As stated, the account number(s) 612 may include thousands of one-time use virtual account numbers associated with the contactless card 102. An applet(s) 608 of the contactless card 102 may be configured to manage the account number(s) 612 (e.g., to select an account number(s) 612, mark the selected account number(s) 612 as used, and transmit the account number(s) 612 to a mobile device or a user device 104 for autofilling by an autofilling service.

In some embodiments, the memory 604 can include (e.g., have stored therein) the data from the fields shown in FIG. 6 and/or FIG. 12. The processor 602 can then use the data from the fields to generate the message 1200 as described above.

The processor 602 and memory elements of the foregoing exemplary embodiments are described with reference to the contact pad 504, but the present disclosure is not limited thereto. It is understood that these elements may be implemented outside of the contact pad 504 or entirely separate from it, or as further elements in addition to processor 602 and memory 604 elements located within the contact pad 504.

In some examples, the contactless card 102 may comprise one or more antenna(s) 618. The one or more antenna(s) 618 may be placed within the contactless card 102 and around the processing circuitry 616 of the contact pad 504. For example, the one or more antenna(s) 618 may be integral with the processing circuitry 616 and the one or more antenna(s) 618 may be used with an external booster coil. As another example, the one or more antenna(s) 618 may be external to the contact pad 504 and the processing circuitry 616.

In an embodiment, the coil of contactless card 102 may act as the secondary of an air core transformer. The terminal may communicate with the contactless card 102 by cutting power or amplitude modulation. The contactless card 102 may infer the data transmitted from the terminal using the gaps in the contactless card's power connection, which may be functionally maintained through one or more capacitors. The contactless card 102 may communicate back by switching a load on the contactless card's coil or load modulation. Load modulation may be detected in the terminal's coil through interference. More generally, using the antenna(s) 618, processor 602, and/or the memory 604, the contactless card 102 provides a communications interface to communicate via NFC, Bluetooth, and/or Wi-Fi communications.

As explained above, contactless card 102 may be built on a software platform operable on smart cards or other devices having limited memory, such as JavaCard, and one or more or more applications or applets may be securely executed. Applet(s) 608 may be added to contactless cards to provide a one-time password (OTP) for multifactor authentication (MFA) in various mobile application-based use cases. Applet(s) 608 may be configured to respond to one or more requests, such as near field data exchange requests, from a reader, such as a mobile NFC reader (e.g., of a mobile device or point-of-sale terminal), and produce an NDEF message that comprises a cryptographically secure OTP encoded as an NDEF text tag.

One example of an NDEF OTP is an NDEF short-record layout (SR=1). In such an example, one or more applet(s) 608 may be configured to encode the OTP as an NDEF type 4 well known type text tag. In some examples, NDEF messages may comprise one or more records. The applet(s) 608 may be configured to add one or more static tag records in addition to the OTP record.

In some examples, the one or more applet(s) 608 may be configured to emulate an RFID tag. The RFID tag may include one or more polymorphic tags. In some examples, each time the tag is read, different cryptographic data is presented that may indicate the authenticity of the contactless card. Based on the one or more applet(s) 608, an NFC read of the tag may be processed, the data may be transmitted to a server, such as a server of a banking system, and the data may be validated at the server.

In some examples, the contactless card 102 and server may include certain data such that the card may be properly identified. The contactless card 102 may include one or more unique identifiers (not pictured). Each time a read operation takes place, the counter(s) 610 may be configured to increment. In some examples, each time data from the contactless card 102 is read (e.g., by a mobile device), the counter(s) 610 is transmitted to the server for validation and determines whether the counter(s) 610 are equal (as part of the validation) to a counter of the server.

The one or more counter(s) 610 may be configured to prevent a replay attack. For example, if a cryptogram has been obtained and replayed, that cryptogram is immediately rejected if the counter(s) 610 has been read or used or otherwise passed over. If the counter(s) 610 has not been used, it may be replayed. In some examples, the counter that is incremented on the card is different from the counter that is incremented for transactions. The contactless card 102 is unable to determine the application transaction counter(s) 610 since there is no communication between applet(s) 608 on the contactless card 102.

In some examples, the counter(s) 610 may get out of sync. In some examples, to account for accidental reads that initiate transactions, such as reading at an angle, the counter(s) 610 may increment but the application does not process the counter(s) 610. In some examples, when the user device 104 is woken up, NFC may be enabled and the user device 104 may be configured to read available tags, but no action is taken responsive to the reads.

To keep the counter(s) 610 in sync, an application, such as a background application, may be executed that would be configured to detect when the mobile user device 104 wakes up and synchronize with the server of a banking system indicating that a read that occurred due to detection to then move the counter(s) 610 forward. In other examples, Hashed One Time Password may be utilized such that a window of mis-synchronization may be accepted. For example, if within a threshold of 10, the counter(s) 610 may be configured to move forward. But if within a different threshold number, for example within 10 or 1000, a request for performing re-synchronization may be processed which requests via one or more applications that the user tap, gesture, or otherwise indicate one or more times via the user's device. If the counter(s) 610 increases in the appropriate sequence, then it possible to know that the user has done so.

The key diversification technique described herein with reference to the counter(s) 610, master key, and diversified key, is one example of encryption and/or decryption a key diversification technique. This example key diversification technique should not be considered limiting of the disclosure, as the disclosure is equally applicable to other types of key diversification techniques.

During the creation process of the contactless card 102, two cryptographic keys may be assigned uniquely per card. The cryptographic keys may comprise symmetric keys which may be used in both encryption and decryption of data. Triple DES (3DES) algorithm may be used by EMV and it is implemented by hardware in the contactless card 102. By using the key diversification process, one or more keys may be derived from a master key based upon uniquely identifiable information for each entity that requires a key.

In some examples, to overcome deficiencies of 3DES algorithms, which may be susceptible to vulnerabilities, a session key may be derived (such as a unique key per session) but rather than using the master key, the unique card-derived keys and the counter may be used as diversification data. For example, each time the contactless card 102 is used in operation, a different key may be used for creating the message authentication code (MAC) and for performing the encryption. This results in a triple layer of cryptography. The session keys may be generated by the one or more applets and derived by using the application transaction counter with one or more algorithms (as defined in EMV 4.3 Book 2 A1.3.1 Common Session Key Derivation).

Further, the increment for each card may be unique, and assigned either by personalization, or algorithmically assigned by some identifying information. For example, odd numbered cards may increment by 2 and even numbered cards may increment by 5. In some examples, the increment may also vary in sequential reads, such that one card may increment in sequence by 1, 3, 5, 2, 2, . . . repeating. The specific sequence or algorithmic sequence may be defined at personalization time, or from one or more processes derived from unique identifiers. This can make it harder for a replay attacker to generalize from a small number of card instances.

The authentication message may be delivered as the content of a text NDEF record in hexadecimal ASCII format. In another example, the NDEF record may be encoded in hexadecimal format.

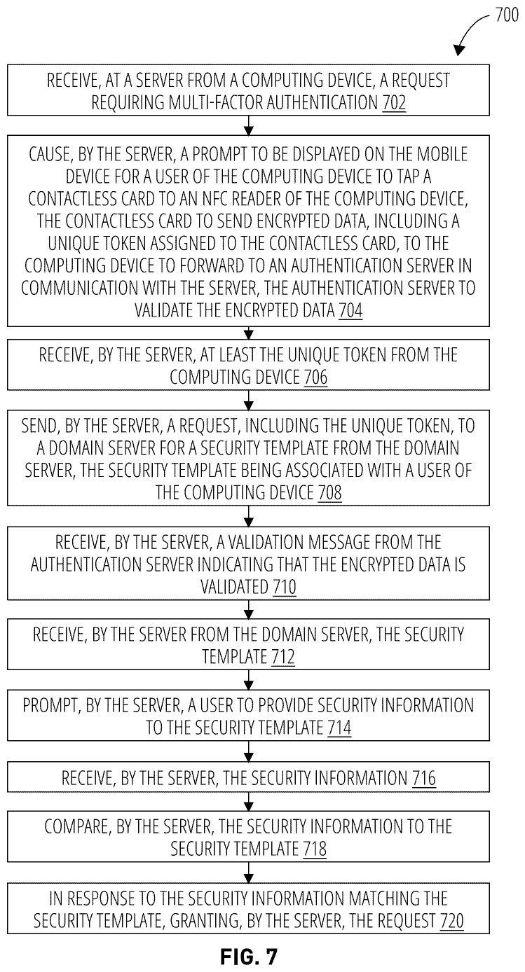

FIG. 7 illustrates example operations performed in some embodiments of a method 700 for distribution of second factor information and validation through a switching network. As shown at block 702, in some embodiments, the method 700 includes receiving, at a server from a computing device, a request requiring multi-factor authentication. As shown at block 704, the method 700 includes causing, by the server, a prompt to be displayed on the computing device for a user of the computing device to tap a contactless card to an NFC reader of the computing device, the contactless card to send encrypted data, including a unique token assigned to the contactless card, to the computing device to forward to an authentication server in communication with the server, the authentication server to validate the encrypted data. As shown at block 706, the method 700 includes receiving, by the server, at least the unique token from the computing device.

As shown at block 708, the method 700 includes sending, by the server, a request, including the unique token, to a domain server for a security template from the domain server, the security template being associated with a user of the computing device. As shown at block 710, the method 700 includes receiving, by the server, a validation message from the authentication server indicating that the encrypted data is validated. As shown at block 712, the method 700 includes receiving, by the server from the domain server, the security template. As shown at block 714, the method 700 includes prompting, by the server, a user to provide security information to the security template. As shown at block 716, the method 700 includes receiving, by the server, the security information. As shown at block 718, the method 700 includes comparing, by the server, the security information to the security template. As shown at block 720, the method 700 includes, in response to the security information matching the security template, granting, by the server, the request.

In some embodiments, the server is a web server hosting a website or a virtual private network (VPN) server configured to establish a VPN and the request is an access request to access the website or a request to establish the VPN. In some other embodiments, the server is a controller or communicates with a controller for controlling access to a physical space, wherein the request is an access request to access the physical space. In some other embodiments, granting the request includes granting, by the server, any request, or performing any other action requested of the server, that requires multi-factor authentication to be performed. In some embodiments, the server is configured to communicate with the computing device using a computer application operating on the computing device, and wherein causing the prompt to appear on the computing device includes the server to send a message to the computing device via the computer application to display the prompt.

In some embodiments, the security template is a biometric template including a type of biometric feature of the user for the computing device to capture. In some embodiments, prompting the user to provide the security information to the security template includes sending, by the server, a request to the computing device to provide the security information according to the type of biometric features in the biometric template. In some embodiments, receiving the security information includes receiving biometric data from the computing device taken of the user, the biometric data taken according to the type of biometric features in the biometric template. In some embodiments, the biometric features of the user includes at least one of facial features, ocular features (e.g., retina, cornea, iris features of the user), hand or finger features, voice features, and gait features of the user.

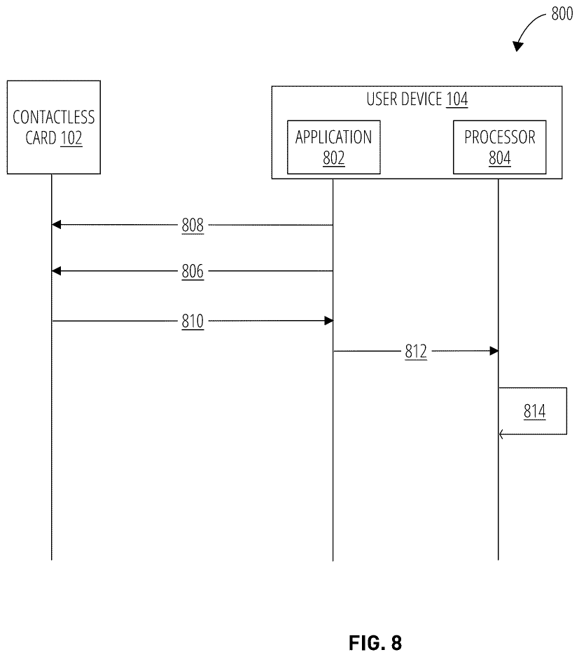

FIG. 8 is a timing diagram illustrating an example sequence for providing authenticated access according to one or more embodiments of the present disclosure. Sequence flow 800 may include contactless card 102 and user device 104, which may include an application 802 and processor 804.

At line 808, the application 802 communicates with the contactless card 102 (e.g., after being brought near the contactless card 102). Communication between the application 802 and the contactless card 102 may involve the contactless card 102 being sufficiently close to a card reader (not shown) of the user device 104 to enable NFC data transfer between the application 802 and the contactless card 102.

At line 806, after communication has been established between user device 104 and contactless card 102, contactless card 102 generates a message authentication code (MAC) cryptogram. In some examples, this may occur when the contactless card 102 is read by the application 802. In particular, this may occur upon a read, such as an NFC read, of a near field data exchange (NDEF) tag, which may be created in accordance with the NFC Data Exchange Format. For example, a reader application, such as application 802, may transmit a message, such as an applet select message, with the applet ID of an NDEF producing applet. Upon confirmation of the selection, a sequence of select file messages followed by read file messages may be transmitted. For example, the sequence may include “Select Capabilities file”, “Read Capabilities file”, and “Select NDEF file”. At this point, a counter value maintained by the contactless card 102 may be updated or incremented, which may be followed by “Read NDEF file.” At this point, the message may be generated which may include a header and a shared secret. Session keys may then be generated. The MAC cryptogram may be created from the message, which may include the header and the shared secret. The MAC cryptogram may then be concatenated with one or more blocks of random data, and the MAC cryptogram and a random number (RND) may be encrypted with the session key. Thereafter, the cryptogram and the header may be concatenated, and encoded as ASCII hex and returned in NDEF message format (responsive to the “Read NDEF file” message).

In some examples, the MAC cryptogram may be transmitted as an NDEF tag, and in other examples the MAC cryptogram may be included with a uniform resource indicator (e.g., as a formatted string). In some examples, application 802 may be configured to transmit a request to contactless card 102, the request comprising an instruction to generate a MAC cryptogram.

At line 810, the contactless card 102 sends the MAC cryptogram to the application 802. In some examples, the transmission of the MAC cryptogram occurs via NFC, however, the present disclosure is not limited thereto. In other examples, this communication may occur via Bluetooth, Wi-Fi, or other means of wireless data communication. At line 812, the application 802 communicates the MAC cryptogram to the processor 804.

At line 814, the processor 804 verifies the MAC cryptogram pursuant to an instruction from the application 802. For example, the MAC cryptogram may be verified, as explained below. In some examples, verifying the MAC cryptogram may be performed by a device other than user device 104, such as a server of a banking system in data communication with the user device 104. For example, processor 804 may output the MAC cryptogram for transmission to the server of the banking system, which may verify the MAC cryptogram. In some examples, the MAC cryptogram may function as a digital signature for purposes of verification. Other digital signature algorithms, such as public key asymmetric algorithms, e.g., the Digital Signature Algorithm and the RSA algorithm, or zero knowledge protocols, may be used to perform this verification.

FIG. 9 illustrates an example of system 900 in accordance with the embodiments discussed herein. The system 900 includes additional devices and systems configured to enable contactless card issuers to tap-to-card services. Specifically, system 900 enables any number of issuer systems to provide card services to their clients through a switching fabric, i.e., the switchboard system in a secure and safe manner.

In embodiments, the switchboard system includes one or more nodes 904 configured to perform routing operations. As described above, one or more of the nodes 904 can be equivalent to the switching network server 402 of FIG. 4 above. The nodes 904 can also be equivalent to or perform some of the same operations as the authentication server 112 of FIG. 1. Each switchboard node 904 may include a session and nonce generator 906, a message router 908, an authentication 910, an operation data 912 store, and a metrics store 914. Further, each of the nodes may be configured the same and share configurations, but each switchboard node 904 may independently process and route messages and requests to the appropriate systems, such as the merchant systems and issuer systems. Each of the nodes 904 is configured to act as a broker of trust between an issuer system, the merchant system 922, and/or validation system 924, for example. Each switchboard node 904 is configured to route each message to the correct issuer system while maintaining data security. For example, a switchboard node 904 may route a message between an issuer system and a merchant system while the node cannot access the private data in the message.

The switchboard system 900 may be configured as a server system with a collection of hardware, software, and networking components that work together to provide client services. Hardware components may include one or more server computers, storage devices, and network adapters. The server computers are configured to run server applications, such as those executable on each of the nodes 904. In some instances, each of the server computers may be configured to operate one or more nodes, e.g., in a virtual environment. The storage devices are configured to store data that is accessed by the applications, and the network adapters are used to connect the server computer to the network.

Each of the server computers may be configured to execute software, including the operating system, the applications, and security software. The networking components of a server system include the network switch, router, and firewall. The network switch is used to connect the server computers to other devices on the network. The router is used to route traffic between different networks. The firewall is used to protect the server system from unauthorized access and attacks.

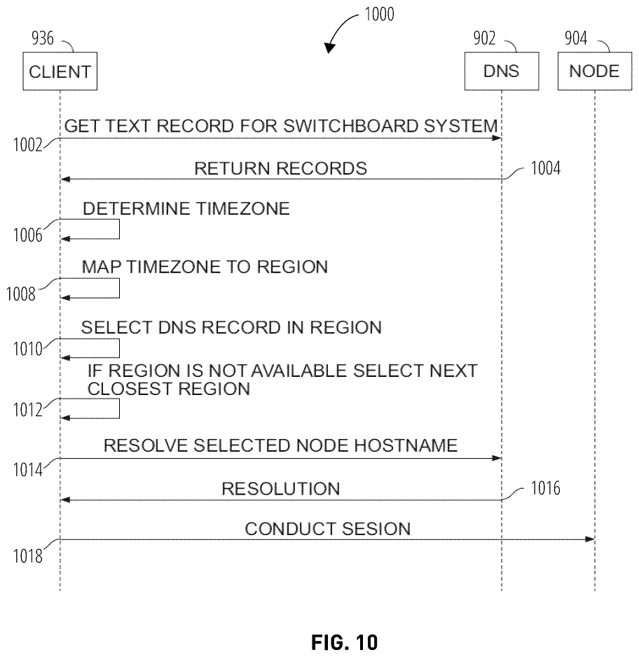

In some embodiments, the nodes 904 may operate in a cloud-based computing environment, e.g., a collection of hardware, software, and networking components that enable the delivery of cloud computing services. The switchboard nodes 904 and the computing services are delivered over the Internet and can be accessed from anywhere in the world with an Internet connection. In embodiments, client 936 may access a switchboard node 904 through DNS 902 or Domain Name System (DNS). The DNS 902 is a hierarchical and distributed naming system for computers, services, and other resources connected to the Internet or other networks. It associates various information with domain names assigned to each registered participant. In one example, the DNS 902 may translate a name known to software executing on a client 936 to route data to one or more of switchboard node 904 of the switchboard system. In embodiments, the DNS 902 may generate a number, such as an Internet Protocol (IP) address, an address record (A-record), or another Hostname (C-name record). FIG. 10 illustrates one example sequence 1000 for a client to identify and resolve an identifier for one of the nodes 904 of the switchboard system. At a high level, the DNS 902 translates known domain names to numerical Internet Protocol (IP) addresses needed for locating and identifying computer services and devices with the underlying network protocols. Clients use the global DNS system to select the best node to use, as discussed in sequence 1000.

In embodiments, a client 936 communicates with the switchboard system to perform one or more of the partner services 932, such as conducting a transaction with a merchant, validating the customer, or other tap-to functions. Once client 936 identifies a switchboard node 904 and resolves an address to communicate with switchboard node 904, client 936 may send one or more messages to switchboard node 904 to authenticate and perform the operation. The switchboard node 904 includes an authentication 910 function that is configured to authenticate the client 936. In embodiments, the client 936 sends a message or authorization request to the switchboard node 904 with the following header set:
X-Sb-Api-Key: <CLIENT API KEY>
X-Sb-Dvc-Fngrprnt: Device-specific device fingerprint

The CLIENT API KEY may have the following example structure: 65535-GReyx5BuEAaE72bWbFZJfHRL8Dbt1Uum, where Table 1 describes the value, name, and meaning:

TABLE 1

| Value | Name | Meaning |
|---|---|---|
| 65536 | Client ID | Individual identifier |
| | | of client |
| GReyx5BuEAaE72bWbFZJfHRL8Dbt1Uum | Client Key | Randomly assigned key |

The switchboard node 904 may authorize or authenticate the client 936 or user, and the switchboard node 904 may utilize the additional components, such as the session and nonce session and node generator 906 and message router 908, to perform the operations. Note the validation systems validation system 924 never interact with the merchant systems 922, nor vice versa. The nodes node 904 brokers all communication.

In embodiments, the switchboard system may utilize a hyper ledger fabric 920 to manage to synchronize the shared operation data 912 and member management across the network. The hyperledger fabric 920 is distributed ledger framework having a permissioned network model that only authorized participants can join the network and access the data that is stored on a ledger.

In embodiments, the hyperledger fabric 920 may be generated by creating one or more sets of peers, an ordering service, and a channel. Once the network is created, system 900 deploys chaincode to the network, or node 904 is permitted to access the fabric. The chaincode is the code that runs on the blockchain and executes the network control 926 and operation data 912 logic code. Once the chaincode is deployed, each of the switchboard nodes 904 is configured to invoke transactions on the blockchain to add data to the blockchain, e.g., the operational data. A switchboard node 904 or another device can query the ledger to retrieve data. The ledger is a distributed database that stores all the data added to the blockchain.

All nodes 904 keep an independently verifiable log of their actions that can be transmitted to a centralized aggregator to build a picture of overall network usage. System 900 can manage network operation data and management at a central level and have a centralized view of network use, aggregated and abstracted to the appropriate level.

FIG. 10 illustrates an example sequence 1000 for a client to utilize DNS to resolve and communicate with one or more nodes of a switchboard system. The illustrated sequence 1000 includes a client 936, a DNS 902, and a switchboard node 904. At 1002, the sequence 1002 includes the client 936 sending a request to a default DNS server for a text record switchboard. {domain}. {tld}. The text record may be preconfigured in a client app and/or client SDK. At 1004, the DNS 902 returns one or more records. A DNS record structure may include the following:
Root Record:
   Name: switchboard. {domain}. {tld}
   Type: TXT
   Resolution:
      {nodename_1}. {operator_a}. {region_i}.switchboard. {domain}. {tld},
      {nodename_2}. {operator_a}. {region_i}.switchboard. {domain}. {tld},
      {nodename_1}. {operator_b}. {region_ii}.switchboard. {domain}. {tld},
      {nodename_2}. {operator_b}. {region_ii}.switchboard. {domain}. {tld},
      * etc.
   Used For determining where there are active nodes
Node Record:
   Name: {nodename}. {operator}. {region}.switchboard. {domain}. {tld}
   Type: A/AAAA or CNAME
   Resolution: Actual node hostname or IP
   Used For: communicating with a node 904

In embodiments, the client 936 may determine the current timezone at 1006. For example, the client app or SDK may utilize a get current timezone function, such as in JavaScript: Intl.DateTimeFormat( ).resolvedOptions( ).timeZone). Embodiments are not limited in this manner, and the app or sdk may determine the timezone via another/different function call. At 1008, the client 936 is configured to map the timezone to a region or short-version identifier of the region. One example includes America/New_York->na-e. The region may be based on DNS names, for example. Table 2 illustrates a few examples of timezone mappings to regions:

TABLE 2

| Timezone | Region | Short Version |
|---|---|---|
| America/New_York | North America/East | na-e |
| America/Buenos_Aires | South America | sa |
| US/Pacific | North America/West | na-w |
| Europe/Paris | Europe | eu |

Embodiments are not limited to these examples, and other timezone-to-region mappings may be utilized. Further and in embodiments, Regions can also be represented as a bidirectional graph structure with the edges representing geographic neighbors. For example, na-e<->na-w and sa<->na-w and sa<->na-e. This representation is useful for node selection.

At 1010, the client 936 may identify or select a DNS record option returned at 1004 that is in the region. If there are multiple matches, the client 936 may select one at random. If there's no node available in a region, the client 936 may determine and use a data graph of neighboring regions to select a node in the closest region where a node is available at 1012. For example, sa has no node but is connected to na-e where there is a node and so na-e is selected. In some embodiments,

At 1014, the client may resolve a selected node's hostname. In embodiments, the client 936 may automatically resolve the hostname using the client's HTTP request default resolver. At 1016, the DNS 902 may return a result. And at 1018, the client 936 may communicate with a switchboard node 904 and begin the process to interact with the switchboard.

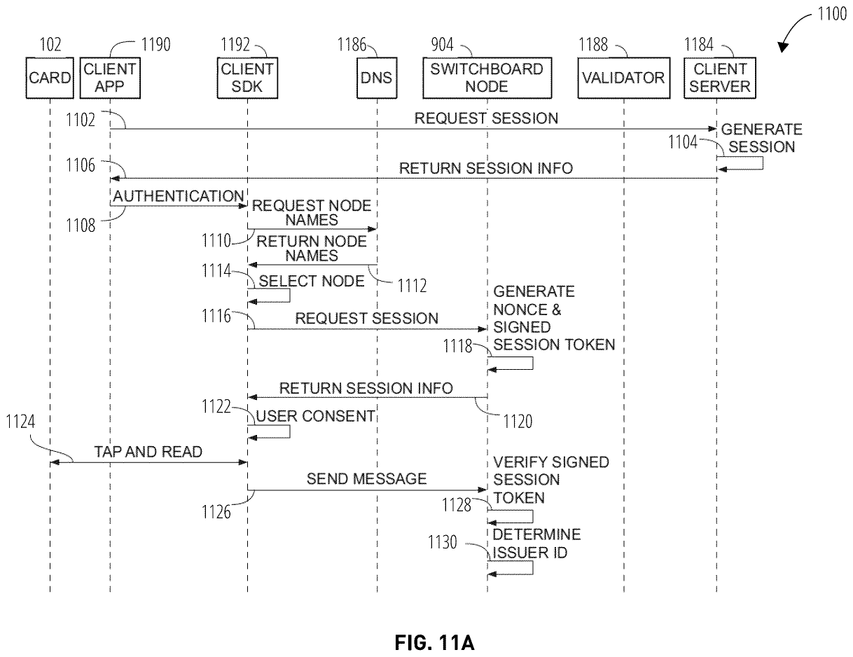

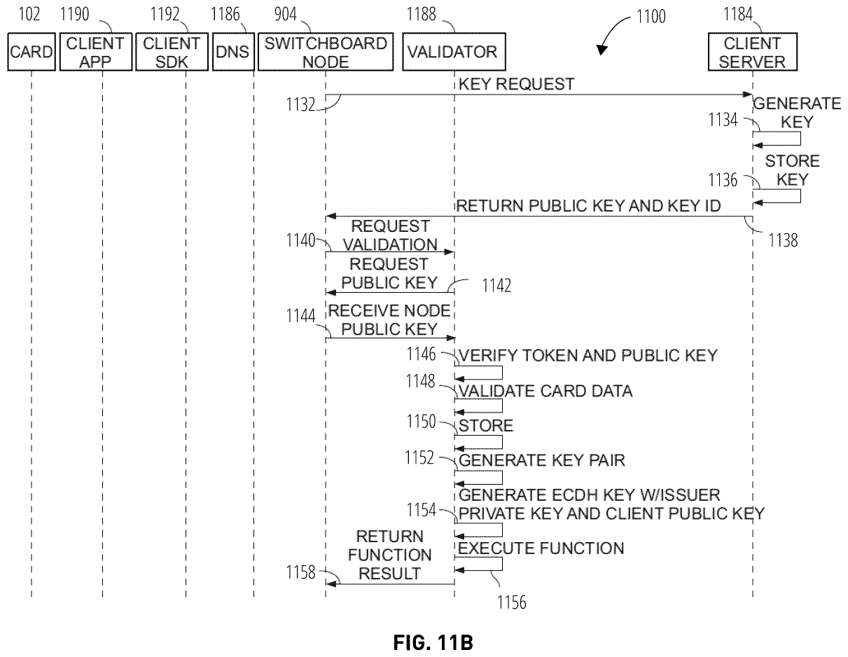

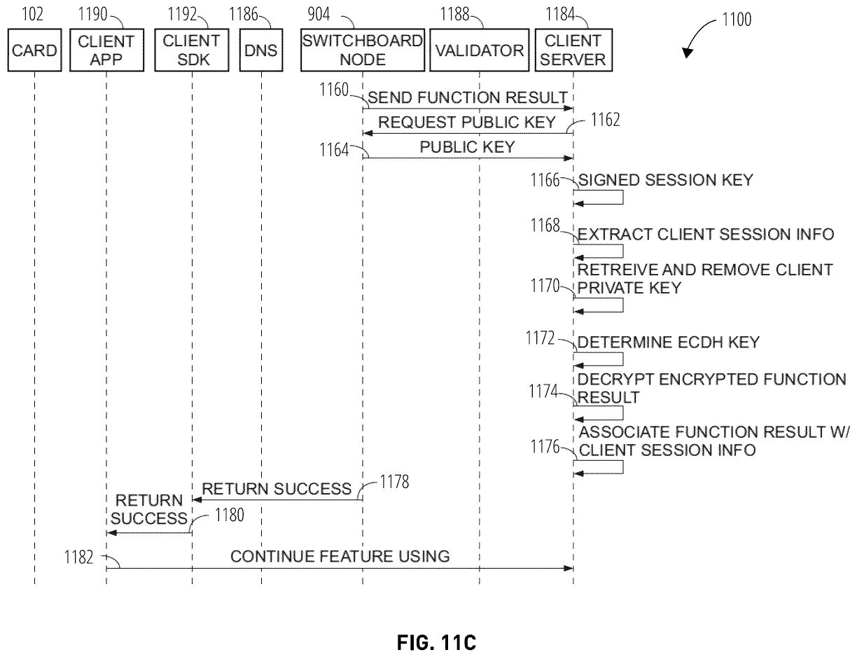

FIG. 11A-FIG. 11C illustrate an example sequence 1100 to perform operations between a contactless card 102 and services provided by a card issuer and/or merchant. The illustrated sequence 1100 includes actions and communications performed by a contactless card 102, a client 936 including a client app 1190 and a client SDK 1192, a DNS 1186, a switchboard system including one or more nodes 904, a partner services 932 including a merchant and/or validator 1188, and control services 934 including a client server 1184 or system. In embodiments, the client app 1190 may be any application configured to execute on a client 936, such as a banking app, a merchant app, a social media app, a travel app, a gaming app, a productivity app, an entertainment app, and so forth. In embodiments, the client app 1190 includes a web browser to provide websites and pages. The client app 1190 may include and/or utilize the client SDK 1192, which may be a set of instructions that enable the client app 1190 to communicate with other components of the switchboard system.

In embodiments, as shown in FIG. 11A, at 1102 the client 936 including the client app may send a request and establish a session with a client server 1184 such that a result may be associated with the correct client device or user. The request establishes a relationship between the client device and client server, which may be an issuer server. At 1104, the client server 1184 generates a session and CLIENT SESSION INFORMATION. At 1106, the client server 1184 returns the session information, e.g., the CLIENT SESSION INFORMATION. In embodiments, the CLIENT SESSION INFORMATION may be the Client implementation-specific user session identification information.

At 1108, the client 936 may initiate a contactless card authentication process with the client 936. For example, the client 936 may call a function and/or pass information to the client 936 to initiate authentication via a contactless card 102. At 1110-1114, the client 936 may utilize DNS to identify a node and establish communication with the node. Specifically, at 1110, the client 936 including the client SDK 1192 may send a request for switchboard hostnames, and at 1112 the DNS 1186 may return information including one or more hostnames. At 1114, the client 936 may determine a switchboard node to communicate. FIG. 10 illustrates an example of a more detailed sequence of the process to establish communication with a switchboard node 904.

At 1116, the client 936 may send a request for a session to the switchboard system 900. In embodiments, the request for a session may be for a function request in the format <FUNCTION REQUEST>. In embodiments, the FUNCTION REQUEST may be the data/function that the client 936 would like to request once a contactless card 102 has been validated. The function could be for any service discussed herein, e.g., authenticate the user, perform a transaction, request autofill data, etc. At 1118, switchboard system 900 may generate a nonce and a signed session token. The signed session token may be a JSON Web Token (JWT). When generating the JWT, the following elements should be set:
iss: The unique ID of the current node,
nonce: An 8 hex character, randomly generated nonce,
exp: The expiration timestamp (+5 minutes),
client_id: The requesting client's Client ID,
sub: The requesting client's Device Fingerprint,
sid: Arbitrary session info sent from the client,
scope: The function being requested to be performed.

The nonce may be unique, random bytes generated to ensure the unrepeatability of a message with a contactless card 102. The nonce is critical to the security and operation of the switchboard system. The nonce validity is tracked by tying it to a session which can be validated by any member of the platform. As mentioned, sessions are JSON Web Tokens signed using a node-specific private key issued by the network. These JWTs are verifiable by a system with the corresponding public key, which they can also verify by confirming it was issued by us or an approved delegate. The signed session token is a JWT-generated token to establish the validity and expiration of the nonce and to associate the contactless card tap to the current client session. For example, the signed session token includes <NONCE>, <CLIENT SESSION INFO>, and <FUNCTION REQUEST>signed with <NODE PRIVATE KEY>, where the NODE PRIVATE KEY is the switchboard system 900 private key. The switchboard system 900 may include a NODE PUBLIC/PRIVATE KEY, which is a keypair used to sign and validate JWTs.

At 1120, the switchboard system 900 may return session information to the client 936. The session information may include the signed session token (<SIGNED SESSION TOKEN>), the NONCE <NONCE>, the function terms of service <FUNCTION TOS>, and the terms of service version <TOS VERSION>. The FUNCTION TOS may be the terms of service that the user must consent to in order to allow the client to execute the requested function, and the TOS VERSION may be the version of the terms of service. At 1122, the client SDK 1192 may determine and/or receive user consent to the terms of service. In one example, the client SDK 1192 captures and records the user consent to <FUNCTION TOS> on <CONSENT DATE> with <TOS VERSION>. The CONSENT DATE may be the timestamp for the user's consent to the TOS.

At 1124, the client 936 exchanges one or more messages with a contactless card. In one example, the exchange may be based on the contactless card being tapped to a client device. In embodiments, the client SDK 1192 may provide data to the contactless card 102 to use during the session to perform the function. The data may be provided to the contactless card 102 in an NDEF message. In one example, the data is written to the card in NDEF format using a binary update command. The data may include a NONCE to provide a level of security that the message received from the card is part of the same session. Additionally, the data may include additional information, such as one or more control bits to control the format generated by the contactless card. Table 3 below illustrates an example of an NDEF message format.

TABLE 3

| Byte | Data Item | Value |
|---|---|---|
| 00 | NDEF Message Tag | D1 (only record) |
| 01 | Length of Record Type | 01 |
| 02 | Length of Record | 33 |
| 03 | text record type | 54 |
| 04 | Length of Language | 02 |
| 05-06 | Language | 65 6E (“en”) |
| 07 . . . 0E | NONCE | 8 bytes of ASCII HEX encoded |
| | | 4 bytes binary data |
| 0F . . . 12 | Session Indicators | 4 bytes of ASCII HEX encoded |
| | | 2 bytes binary data |
| 13 . . . 16 | Control Indicators | 4 bytes of ASCII HEX encoded |
| | | 2 bytes binary data |
| 17 . . . 26 | Update Date | 16 bytes of ASCII HEX encoded |
| | creation Time | 8 bytes binary data - represents |
| | | 64 bit unix timestamp |
| 27 . . . 36 | Update MAC | MAC to protect control indicators - |
| | | 16 bytes of ASCII HEX encoded |
| | | 8 bytes binary data |

The updated MAC may be calculated to protect the control indicators in embodiments. Specifically, The MAC M is determined by calculating a MAC over the 10 bytes of the update data U with the Update MAC Card Key (MCK), as described in FIG. 12, message 1200.

At 1124, the contactless card may generate and provide a message to the client's device including the client SDK 1192. The data in the message may be utilized by the system discussed herein to perform the function requested. One example of the message is illustrated and discussed in FIG. 12, message 1200.

At 1126, the client including the client SDK 1192 may send a message and information to the switchboard system 900. The message may be the message received from the contactless card 102, e.g., message 1200. In addition, the client SDK 1192 may send the consent date, the TOS version, and the signed session token to the switchboard system 900. The switchboard system 900 may utilize the information to ensure the session is valid. At 1128, the switchboard system 900 verifies the signed session token is valid, e.g., is the previously provided signed session token and includes the nonce previously generated and is in the message.

In some embodiments, the switchboard system 900 is configured to determine which issuer system or client-server it should route the message to for processing. At 1130, the switchboard system 900 may determine the issuer ID by extracting it from the message received from the contactless card 102 via the client SDK 1192. As mentioned, the issuer ID identifies the issuer of the contactless card 102.

FIG. 11B continues the sequence 1100 from FIG. 11A. In embodiments, the switchboard system 900 is configured to generate and communicate secure communications with the issuer system, e.g., the client server 1184 and the validator 1188. At 1132, the switchboard system 900 sends a request for a key to the client server 1184. The key may be utilized to perform secure communications. In one example, the key request may be an elliptical curve Diffie-Hellman (ECDH) key request. Embodiments are not limited in this manner. Alternative key protocols may be utilized, e.g., Supersingular isogeny Diffie-Hellman key exchange (SIDH or SIKE), a private/public key pairing (RSA), etc.

At 1134, the client server 1184 generates a portion of the key. In some instances, the client server 1184 may generate half of the ECDH key for encryption/decryption of PII. Specifically, the client server 1184 may generate <CLIENT EC PUBLIC KEY> and <CLIENT EC PRIVATE KEY> using Elliptic Curve P256. The CLIENT EC PUBLIC KEY AND CLIENT EC PRIVATE KEY is the first half of the ECDH key negotiation.

At 1136, the client-server 1184 stores the generated portion of the key in storage. Specifically, the client server 1184 may store <CLIENT EC PUBLIC KEY> and <CLIENT EC PRIVATE KEY> with <KEY ID>, where the KEY ID is used by the Client Server to cache its short-lived EC public/private key for later ECDH key completion, e.g., to identify the ECDH key portions to generate the whole ECDH key. In one example, the key may be stored in a secure memory location and may be used to when PII is received for the session.

In embodiments, the client server 1184 may return the public key portion to the switchboard system 900 with the KEY ID at 1138. The switchboard system 900 may store the public key portion with the KEY ID for later use, e.g., generation of the ECDH key. At 1140, the switchboard system 900 may request a validation to be performed by the validator 1188. In one example, the switchboard system 900 may send a request validation as Request validation <MESSAGE>, <SIGNED SESSION TOKEN>, <CLIENT EC PUBLIC KEY>, <CONSENT DATE>, and the <TOS VERSION>. The validator 1188 may make an out-of-band request back to the switchboard system 900 for the public key to verify the session at 1142. At 1144, the switchboard system 900 may provide the node's public key, i.e., <NODE PUBLIC KEY>. Further at 1146, the validator 1188 may utilize the node's public key to verify the secure session token.

In embodiments, the validator 1188 may validate the message at 1148. In embodiments, the validator 1188 may perform a number of validations including ensuring the nonce in the message is correct along with additional information, such as the card's unique identifier (pUID), and the counter value (pATC).

At 1150, the validator 1188 may store information associated with the session. For example, validator 1188 may store the <CONSENT DATE> with the <TOS VERSION> and the <PUID>. The validator 1188 may also generate another portion of the key, e.g., the ECDH key. For example, the 1188 may Generate <ISSUER EC PUBLIC KEY> and <ISSUER EC PRIVATE KEY> using Elliptic Curve P256. The ISSUER EC PUBLIC KEY and ISSUER EC PRIVATE KEY may be the second half of the ECDH key negotiation.

At 1154, the validator 1188 may generate the complete ECDH key. For example, the validator 1188 generates the <ECDH KEY> from <ISSUER EC PRIVATE KEY> and <CLIENT EC PUBLIC KEY>. The ECDH KEY is the final key generated using ECDH key negotiation.

The validator 1188 may utilize the ECDH KEY to encrypt data for the function. For example, if the validator 1188 validates the message in some instances, the validator 1188 may execute a function request to create a function result and encrypt the result with the ECDH KEY at 1156. For example, the validator 1188 may Execute <FUNCTION REQUEST> to create <FUNCTION RESULT> and encrypt it with the <ECDH KEY>. The function result may be any result based on the requested function, e.g., verification of the card.

At 1158, the validator 1188 may return the function result to the switchboard system 900. In some instances, the function result is returned encrypted. For example, the validator 1188 may return the <ENCRYPTED FUNCTION RESULT> and the <ISSUER EC PUBLIC KEY>.

FIG. 11C continues the sequence 1100 from FIG. 11B. In embodiments, at 1160 the switchboard system 900 sends the function result to the client server 1184 to process the result. In one example, the switchboard system 900 may send the <ENCRYPTED FUNCTION RESULT>, <KEY ID>, <ISSUER EC PUBLIC KEY>, and <SIGNED SESSION TOKEN>. At 1162 and 1164, the client server 1184 may make a request for and receive the public key from the switchboard system 900. In some instances, the exchange may be performed via out-of-band communication channels. The public key for the node may be <NODE PUBLIC KEY>. The public key may be used to verify the sender of the function result, etc. At 1166, the client server 1184 may verify the signed session key with the node's public key <NODE PUBLIC KEY> to verify the sender of the information. At 1168, the client server 1184 may extract client information from the signed session token. For example, the client server 1184 may Extract <CLIENT SESSION INFO> from <SIGNED SESSION TOKEN>, i.e., extracting the client implementation-specific user session identification information.

Further, at 1170, the client server 1184 may retrieve the client's private key with the KEY ID. Specifically, the client server 1184 may get and remove the <CLIENT PRIVATE KEY> from cache using the <KEY ID>. At 1172, the client server 1184 may generate or compute the ECDH key. For example, the client server 1184 may compute the <ECDH KEY> with the <CLIENT PRIVATE KEY>+<ISSUER EC PUBLIC KEY>. The client server 1184 may decrypt the function result with the computed key at 1174. Specifically, the client server 1184 may decrypt the <ENCRYPTED FUNCTION RESULT> with the <ECDH KEY> to determine the <FUNCTION RESULT>. At 1176, the client server 1184 associates the function result with the session.

In embodiments, the switchboard system 908 may return whether the function result was successfully completed or not at 1178 to the client SDK 1192. Further at 1180, the client SDK 1192 may notify the client app 1190 of the result. At 1182, the client app 1190 may utilize the feature. For example, the 1182 may communicate with the client server 1184 to continue the feature using the <CLIENT SESSION INFO> to fetch the redacted <FUNCTION RESULT>.

FIG. 12 illustrates an example of a message 1200 that may be communicated by a contactless card to perform the functions described herein, such as those discussed in FIG. 11A through FIG. 11C. The message 1200 can be or include the encrypted data sent from the contactless card 102 to the user device 104 and the authentication server 112 in FIG. 1. The pUID 1210 described below can be the unique token provided to the domain server 110 to determine the biometric template for the user of the contactless card 102. One or more of the fields in message 1200 may also be utilized to route the message 1200 through the switchboard system and perform authentication/validation techniques.

In embodiments, the message 1200 includes an applet version 1202 field, an issuer discretionary indicator 1204 field, an Issuer Identifier 1206 field, a pKey ID 1208 field, a pUID 1210 field, a pATC 1212 field, a nonce 1214 field, and an encrypted cryptogram 1216.

In embodiments, the fields may be in plain text or encrypted. For example, the applet version 1202 field may include an applet version in plain text. The applet version indicates which applet version is installed on a contactless card and may be used by the other systems to determine how to process the message 1200 when communicated. For example, different Applet versions require different validation logic, e.g., an older message may be routed through the issuer system to perform various operations for validation, while a newer message may be routed through the switchboard system to perform the various operations, including validation.

In embodiments, the message 1200 includes an issuer discretionary indicator 1204 field that may include issuer data and set at the time of personalization. In addition, the message 1200 includes an Issuer Identifier 1206 field that may include a unique ID assigned to the entity issuing the card, e.g., the issuer. For example, when joining the system, each issuer may be assigned a unique identifier during an onboarding operation. The issuer ID can be used by the switchboard system 908 to route a message and its contents to the appropriate services that are associated with that particular issuer.

In embodiments, the message 1200 includes a pKey ID 1208 field. In some instances, the pKey ID 1208 field may include data that identifies a set of master keys for a card issuer. The issuer's set of master keys may utilize each card's set of derived master keys or unique derived keys (UDK). Further, each card's own set of master keys (UDKs) may be generated during the personalization of the card. The card's UDKs may be utilized to generate session keys that are used to generate the application cryptogram. The session keys generated by a card may be regenerated by a system, e.g., the validator system, utilizing pKeyID to identify the issuer's master keys to regenerate session keys by the system to perform a validation.

In embodiments, each contactless card 102 is given a unique 16-decimal digit identity (pUID) at the time of personalization. Derivation of the card applet's unique keys using the pUID is performed off-card. The resultant Application Keys are injected during the personalization of the card. In embodiments, a card's Application Keys are the same as the card's derived master keys or UDKs. The process for deriving the Application Keys (UDKs) is described herein.

The message 1200 may include a pUID 1210 field, including a card unique identifier assigned to the contactless card at personalization time. The pUID 1210 field data may be a combination of alphanumeric characters used to identify each card and associated with a user uniquely.

In embodiments, the message 1200 includes a pATC 1212 field configured to hold a counter value. The counter value keeps a count of reads (taps) made on the contactless card in a hexadecimal format in one example. Further, a counter value may be used to generate session keys to encrypt at least a portion of a message.

In embodiments, each time a message 1200 is created, a new session key is derived and utilized to generate one or more portions of the message 1200. Specifically, a session key is used to calculate the cryptographic MAC (Application Cryptogram). The card's applet supports a session key derivation option to generate a unique cryptogram session key ASK, and a unique encipherment session key (DESK).

In embodiments, a portion of the data provided in message 1200 is static and set on the card during the personalization of the card and other data is dynamic and may be generated by the card during an operation, e.g., when a read operation is being performed. Note that in some instances, the static information may be updateable, but may require the customer and card to go through a secure update process, which may be controlled by the issuer.

In embodiments, the contactless card 102 may communicate a message between a device, such as a mobile device, during a read operation. For example, in response to the contactless card 102 being tapped onto a surface of the device, e.g., brought within wireless communication range, a read operation may be performed on the contactless card 102, and the contactless card 102 may generate and provide the message to the device. For example, once within range, the contactless card 102 and the device may perform one or more exchanges for the contactless card 102 to send the message to the device.

The wireless communication may be in accordance with a wireless protocol, such as near-field communication (NFC), Bluetooth, WiFi, and the like. In some instances, a message may be communicated between a contactless card 102 and a device via wired means, e.g., via the contact pad, and in accordance with the EMV protocol.

As discussed above, the contactless card 102 may be deployed with a unique card key, e.g., the UDK, that is generated from an issuer's master key and is used to generate session keys. The following discusses the generation of the UDK and the session keys (ASK) and (DESK). Further, the contactless card may generate encrypted data or a cryptogram comprising data as discussed herein with the generated keys. The encrypted data may be encrypted with session keys that are changed each time data is encrypted. In one embodiment, the session keys are generated from card master keys or unique diversified keys that are stored on the contactless card 102. The unique diversified keys may be generated from the issuer's master keys. For example, in some instances, operations to generate the unique diversified keys may be performed off the card at personalization time and then stored in the memory of the card. Further, the issuer's master key(s) may be utilized to generate card master keys. The card master keys may also be known as application keys or UDKs. Each contactless card may have one or more UDKs.

In embodiments, each contactless card includes one or more applications, such as an authentication application, that is given a unique 16-digit identity (pUID) at time of personalization. Each contactless card may also receive application keys, which may also be known as unique card keys (UDKs) or card master keys using the pUID. In some instances, these operations are performed off-card, and the resultant keys are injected during personalization. However, in other instances, one or more of the operations may be performed on the card, e.g., at the time of manufacturer, each time an operation is performed with a key, and so forth.

Embodiments include a system configured to generate a number of issuer master key sets and assign each a unique three-byte pKey identifier (pKey ID). As mentioned, systems discussed herein may support many card issuers, and each card issuer may have one or more of its own sets of unique issuer master keys that can be identified with a pKey ID. For each application, such as the authentication application, the system may perform the following operations to generate application keys or UDKs.

In embodiments, the system assigns a pKey ID to a card or pUID, a card application's unique 16-decimal digital identity. The system initiates generating a card's UDK(s). Specifically, the system generates a 16-digit quantity (X) from the 16-digit pUID. In one example, the 16-digit X may be generated by randomly rearranging the 16-digit pUID. In another example, X may be the same as the 16-digit pUID. Embodiments are not limited in this manner, and other techniques may be utilized to generate X from the 16-digit pUID. In embodiments, the 16-digit quantity X may be utilized to generate one or more UDKs.

In instances, the system computes or calculates a first portion (ZL) by encrypting X with an issuer master key. An encryption algorithm, such as DES or DES variant, may be utilized in embodiments. Embodiments are not limited in this manner, and other examples of encryption algorithms include AES and public-key algorithms, such as (RSA).

The system calculates or computes a second portion ZR by XOR'ing X with FFFFFFFFFFFFFFFF and encrypting the result with an issuer master key. Again, an encryption algorithm such as DES, AES, RSA, etc, may be used to encrypt the result of the XOR'ing. The system generates an application key or UDK. Specifically, the system concatenates ZL with ZR to form the application key. Embodiments are not limited to concatenating the two portions (ZL and ZR). They may be combined using other techniques. Additionally, the above-described process can be performed any number of times to generate additional application keys, e.g., by utilizing different master issuer keys. In embodiments, a contactless card 102 stores the generated application key(s) or UDK(s).

In embodiments, the contactless card 102 utilizes the application key(s) or UDK(s) to generate session keys for each encrypted data is generated. The following is one processing flow that may be performed by the contactless to generate a unique cryptogram session key (ASK).

To generate the ASK, the contactless card 102 computes SKL by encrypting [ATC[2]∥ATC[3]∥‘F0’∥‘00’∥[ATC[0]∥[ATC[1]∥[ATC[2]∥[ATC[3]] with an application key. Further, the contactless card 102 computes SKR by encrypting [ATC[2]∥ATC[3]∥‘0F’∥‘00’∥[ATC[0]∥[ATC[1]∥[ATC[2]∥[ATC[3] with the application key. Finally, the contactless card 102 concatenates SKL with SKR to form an authentication session key (ASK). In embodiments, the ASK is used to perform operations utilizing the contactless card 102, such as encrypting the cryptographic MAC.

In embodiments, the contactless card 102 also supports session key derivation to generate a unique encipherment session key DESK. The contactless card 102 computes an SKL by encrypting [ATC[2]∥ATC[3]∥‘F0’∥‘00’∥‘00’∥‘00’∥‘00’∥‘00’] with a Data Encryption Key (DEK) or UDK. Further, the contactless card 102 computes SKR by encrypting [ATC[2]∥ATC[3]∥‘0F’∥‘00’∥‘00’∥‘00’∥‘00’∥‘00’] with the DEK or UDK. The contactless card 102 concatenates SKL with SKR to form the Data Encipherment Session Key (DESK).

In embodiments, the contactless card 102 generates encrypted data or a cryptogram utilizing the session keys. Specifically, the contactless card 102 generates a cryptogram C by calculating a MAC over the 32-byte transaction data T using the Authentication Session Key (ASK).

The contactless card 102 may process the data to generate the cryptogram. Specifically, the contactless card 102 divides T into four blocks of 8 bytes of data: T=T1∥T2∥T3∥T4. The contactless card 102 computes B=DES (ASKL) [T1], where is the Data Encryption Standard or another symmetric encryption algorithm, ASKL is a portion of the ASK, e.g., the “left” half of the key. The contactless card 102 computes B=[B XOR T2], and, the contactless card 102 computes B=DES (ASKL) [B], where DES is an encryption algorithm. The contactless card 102 computes B=[B XOR T3], and the contactless card 102 computes B=DES (ASKL) [B]. The contactless card 102 computes B=[B XOR T4], and the contactless card 102 computes B=DES (ASKL) [B]. The contactless card 102 computes B=DES⁻¹ (ASKR) [B], where DES⁻¹ is the reciprocal DES operation, and ASKR is a portion of the ASK, e.g., the right half. The contactless card 102 computes the cryptogram C=DES (ASKL) [B].

In embodiments, a contactless card 102 may also encipher the cryptogram to secure the data further. For example, a contactless card 102 may generate an 8-byte random number [RND] and the card computes E1=DES3(DESK) [RND], where DES3 is a symmetric encryption algorithm such as the Triple Data Encryption Standard. The contactless card 102 then computes B=[E1] XOR [C], where C is the cryptogram generated, as discussed above. The contactless card 102 computes E2=DES3(DESK) [B], where B is computed above. Further, the contactless card 102 generates the 16-byte enciphered payload E=[E1]∥[E2].

In embodiments, a device or the contactless card 102 may decrypt the payload E by determining, receiving, or retrieving the payload E. The device computes a RND=DES3⁻¹(DESK) [E1]. The device determines B=DES3⁻¹(DESK) [E2], and the device computes C=[E1] XOR [B].

In embodiments, the contactless generates or calculates a message authentication code (MAC). In some instances, the MAC may be an updated MAC. In embodiments, the updated MAC is included in data communicated from a contactless card 102 to another device, such as a mobile device, point-of-sale (POS) terminal, or any other type of computer. In one example, the updated MAC may be included in an NDEF message.

In embodiments, the updated MAC may be calculated to protect the control indicators and include an updated date/time. For example, the update MAC M is determined by calculating a MAC over the 10 bytes of the updated data U with the Updated MAC Card Key (MCK) as follows.

Embodiments include determining data to process through a number of calculations and computations. In one example, the data U equals the [Control Indicators (2 bytes)∥Update Date Time (8 bytes)∥‘80’∥‘00 00 00 00 00’]. For the calculations, the data may be divided into two separate portions. Specifically, the data U is broken into two blocks of 8 bytes of data, where U=U₁∥U₂. Further, operations may be performed on U₁ and U₂.

Embodiments include applying an algorithm to the first portion (U₁) of the data. In one example, a result B may be computed where B=DES (MCKL) [U₁], where DES is a Data Encryption Standard algorithm using a first portion (L) of the MAC Card Key (MCKL).

Further, an additional operation may be performed on the result B. Specifically, the result B may be exclusively or'd (XOR) with a second portion of the data (U₂).

The updated result B may be further processed. For example, result B may be further processed by applying the DES algorithm using MCKL again to B. The result the inverse DES may process B with a second portion (R) of the MCK (MCKR), and the MAC M may be determined by applying the DES algorithm with the MCKL to result B.

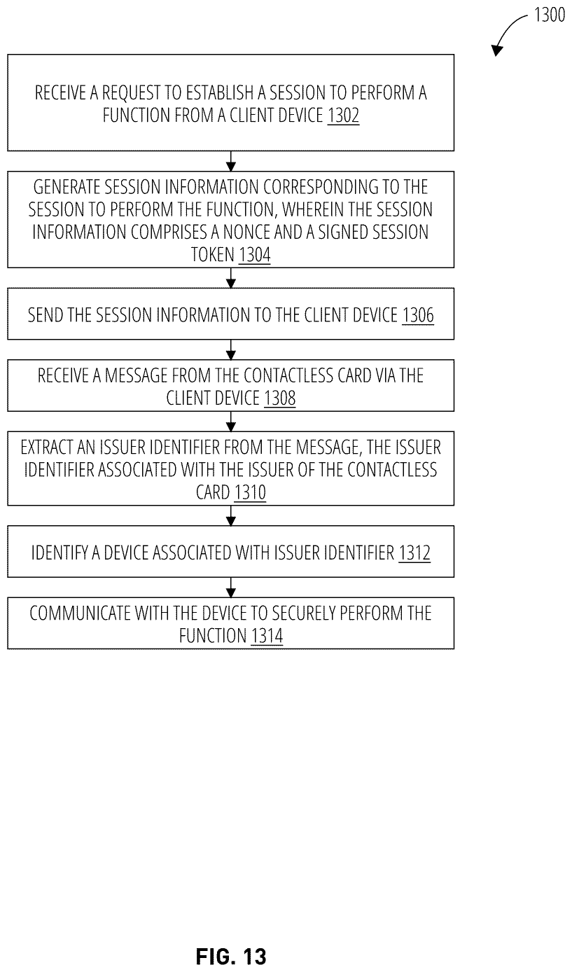

FIG. 13 illustrates an example of method 1300 in accordance with embodiments discussed herein. In block 1302, the method 1300 includes receiving, by a node in a system, a request to establish a session to perform a function from a client device, wherein the function is at least partially performed utilizing a contactless card, such as contactless card 102. In some instances, the node may be one of a plurality nodes of a switchboard system. The node may be previously selected by the sending device via a DNS operation performed.

In block 1304, the method 1300 includes generating, by the node, session information corresponding to the session to perform the function, wherein the session information comprises a nonce and a signed session token. The nonce and/or signed session token may be utilized by systems to perform the functions described herein while ensuring the node routing the data is authenticated, the message from the contactless card is authenticated, and to keep track of the session for the function.

In block 1306, method 1300 includes sending the session information to the client device by the node. The client device may communicate with a contactless card to receive data from the card to authenticate and perform a function. In some instances, the client device may send the nonce from the node to the contactless card. The contactless card may utilize the nonce when generating the message to communicate back to the client device. Finally, the node, e.g., incorporates it into a cryptographic portion of the message (see FIG. 12).

In block 1308, method 1300 includes receiving, by the node, a message from the contactless card via the client device. The message may be generated by the contactless card. FIG. 12 illustrates one example of a message 1200. In some embodiments, the node verifies the message. For example, the node may verify a nonce in the message and a signed session token.

In block 1310, method 1300 extracts an issuer identifier from the message by the node, the issuer identifier associated with the issuer of the contactless card. In some instances, the issuer identifier may be in a plaintext format.

In block 1312, method 1300 identifies, by the node, a device associated with the issuer identifier. For example, the node may perform a lookup to determine a server associated with the issuer identifier and the function to be performed.

In block 1314, method 1300 communicates, by the node, with the device to securely perform the function.

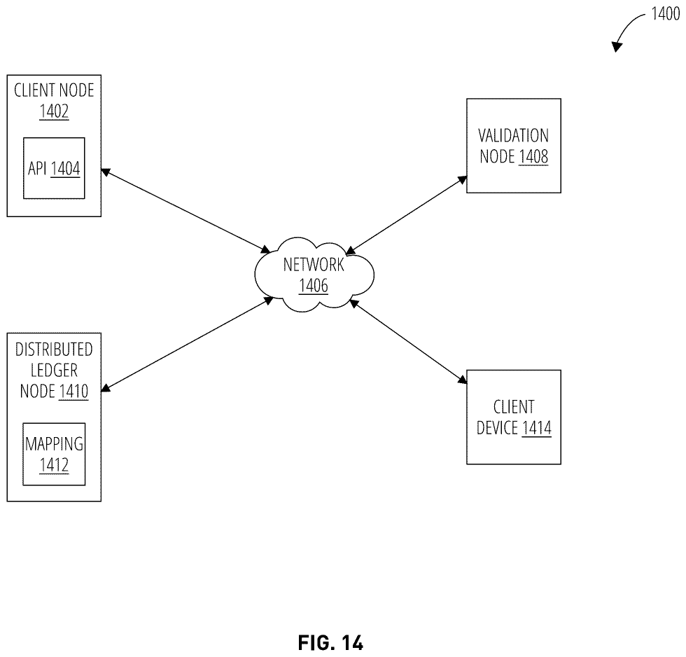

FIG. 14 illustrates a distributed network authentication system 1400 according to an example embodiment. As further discussed below, system 1400 can include client node 1402, API 1404, network 1406, distributed ledger node 1410, mapping 1412, and client device 1414. Although FIG. 14 illustrates single instances of the components, system 1400 can include any number of components.

System 1400 can include a client node 1402, which can be a network-enabled computer as described herein. In some examples, client node 1402 can be a server, which can be a dedicated server computer, a bladed server, or can be a personal computer, a laptop computer, a notebook computer, a palm top computer, a network computer, a mobile device, a wearable device, or any processor-controlled device capable of supporting the system 1400.

In some examples, client node 1402 can execute one or more applications, such as software applications, that enable, for example, network communications with one or more components of system 1400, transmit and/or receive data, and perform the functions and processes described herein.

The client node can contain an API 1404. For example, various different APIs can be provided for an application (e.g., executed on a computing device, such as a network-enabled computer) that can interact with a service. For example, an application executed on a device (e.g., a smart phone, smart watch, tablet, laptop, or other device) call interact with a web-based service by calling the API 1404 to interact with the service, such as by performing a remote call to an API for interacting with a web-based service.

API 1404 can be provided in the form of a library that includes specifications for routines, data structures, object classes, and variables. In some cases, such as for representational state transfer (REST) services, an API (e.g., a REST API or RESTful API, or an API that embodies some RESTful practices) is a specification of remote calls exposed to the API consumers (e.g., applications executed on a client computing device can be consumers of a REST API by performing remote calls to the REST API). REST services generally refer to a software architecture for coordinating components, connectors, and/or other elements, within a distributed system (e.g., a distributed hypermedia system).

Client node 1402 can communicate with one or more other components of system 1400 either directly or via network 1406. Network 1406 can comprise one or more of a wireless network, a wired network or any combination of wireless network and wired network, and may be configured to connect the components of system 1400. While FIG. 14 illustrates communication between the components of system 1400 through network 1406, it is understood that any component of system 1400 can communicate directly with another component of system 1400, e.g., without involving network 1406.

System 1400 can include a validation node 1408, which can be a network-enabled computer as described herein. In some examples, validation node 1408 can be a server, which can be a dedicated server computer, a bladed server, or can be a personal computer, a laptop computer, a notebook computer, a palm top computer, a network computer, a mobile device, a wearable device, or any processor-controlled device capable of supporting the system 1400.

In some examples, validation node 1408 can execute one or more applications, such as software applications, that enable, for example, network communications with one or more components of system 1400, transmit and/or receive data, and perform the functions and processes described herein.

In some examples, each validation node can be associated with a routing number, and the routing number identifies the entity controlling the keys for the authentication namespace. The authentication namespace can be related to one or more of a particular entity, a particular set of cards, or a particular set of security keys (e.g., master keys, diversified keys, session keys) associated with an entity, a set of cards, or a type of cards.

System 1400 can include a distributed ledger node 1410, which can be a network-enabled computer as described herein. In some examples, distributed ledger node 1410 can be a server, which can be a dedicated server computer, a bladed server, or can be a personal computer, a laptop computer, a notebook computer, a palm top computer, a network computer, a mobile device, a wearable device, or any processor-controlled device capable of supporting the system 1400.

In some examples, distributed ledger node 1410 can execute one or more applications, such as software applications, that enable, for example, network communications with one or more components of system 1400, transmit and/or receive data, and perform the functions and processes described herein.

Distributed ledger node 1410 can containing a mapping 1412. In some examples, mapping 1412 can be in the form of one or more databases. Exemplary databases can include, without limitation, relational databases, non-relational databases, hierarchical databases, object-oriented databases, network databases, and any combination thereof. The one or more databases can be centralized or distributed. The one or more databases can be hosted internally by any component of system 1400, or the one or more databases can be hosted externally to any component of the system 1400. In some examples, the one or more databases can be contained in the distributed ledger node 1410, and in other examples the one or more databases can be stored outside of distributed edger node 1410 but in data communication with distributed ledger node 1410. The one or more databases can be implemented in a database programming language. Exemplary database programming languages include, without limitation, Structured Query Language (SQL), MySQL, HyperText Markup Language, JavaScript, Hypertext Preprocessor Language, Practical Extraction and Report Language, Extensible Markup Language, and Common Gateway Interface. Queries made to the one or more databases can be implemented in the same database programming language used to implement the one or more databases. For example, if the one or more databases are an SQL database, then queries made to the database can be made in SQL (e.g., SELECT column1, column2 FROM table1, table2 WHERE column2=‘value’;). It is understood that the one or more databases can be implemented in any database programming language and that the programming implementation of the query can be adjusted as necessary for compatibility with the one or more databases and to reflect the particular information to be queried.

In some examples, the one or more databases can be contained within distributed ledger node 1410. In other examples, the one or more databases can be remote from distributed ledger node 1410 but in data communication with distributed ledger node 1410. Data communication between the one or more databases and distributed ledger node 1410 can be a direct data communication or data communication via a network, such as the network 1406.

In some examples, client node 1402 can be in data communication with distributed ledger node 1410. Distributed ledger node 1410 can contain mapping 1412. Mapping 1414 may include, e.g., a mapping between a validation node address and the validation node 1408, a mapping between a routing number and a validation node address, and/or a mapping between a routing number and validation node 1408. In some examples, mapping 1412 can include a digital signature associated with an entity having permission to validate for a routing number. Based on one or more of these associations, client node 1402 can call validation node for validation and/or provide direction to the client device to reach the appropriate validation node. This can be accomplished by calling a validation API associated with validation node 1408.

In some examples, iterations of the mappings described herein, such as mapping 1412, can also include a software or applet version number. The version number can be used to identify a validation node or validation node address or choose between multiple validation addresses for one validation node.

In some examples, client node 1402 and distributed ledger node 1410 can be permissioned (e.g., allowed to join a network) with the aid of a certificate and/or a cryptographic authentication mechanism (e.g., a non-fungible token). The certificate and/or a cryptographic authentication mechanism may be issued by, e.g., a consortium authority or other administrative entity associated with the distributed network. If granted appropriate permissions, distributed ledger node 1410 can update mapping 1412 to reflect a different association between, e.g., a routing number, a validation node address, and a validation node. In some examples, degrees of permissions can be issued. For example, if client node 1402 were to function to route data to validation node 1408 (or other validation nodes), client node 1402 can be given a certain level of permissions. As another example, if distributed ledger node 1410 were to have the capability to update mapping 1412, distributed ledger node 1410 can have a different, higher level of permissions.

System 1400 can include a client device 1414, which can be a network-enabled computer as described herein. In some examples, distributed ledger node 1414 can be a server, which can be a dedicated server computer, a bladed server, or can be a personal computer, a laptop computer, a notebook computer, a palm top computer, a network computer, a mobile device, a wearable device, or any processor-controlled device capable of supporting the system 1400. Client device 1414 also may be a mobile device; for example, a mobile device may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device. In some examples, client device 1414 can be in data communication with another network-enabled computer not shown in FIG. 14, such as a smart card (e.g., a contactless card or a contact-based card).

In some examples, client device 1414 can execute one or more applications, such as software applications, that enable, for example, network communications with one or more components of system 1400, transmit and/or receive data, and perform the functions and processes described herein.

In some examples, upon receipt of an authentication request, client device 1414 can call (e.g., via an API) client node 1402. The call can include a routing number and/or an applet or software version number, and client node 1402 can query distributed ledger node 1410 and mapping 1412. Once the query returns the identification of a validation node (e.g., validation node 1408) and/or a validation node address associated with that routing number and/or applet or software version, client node 1402 can reply to client device 1414. Client device 1414 can then proceed with authentication with the validation node. The authentication can be performed by, e.g., the systems and methods described herein, such as by the generation, encryption, transmission, decryption, and validation of a cryptogram as described herein.

In some examples, client node 1402 can be co-resident with validation node 1408. In these examples, client node 1402 can handle the authentication in a single call from client device 1414. In some examples, this can be acceptable only if it is permissible for the full authentication transmission (e.g., a cryptogram as described herein) to be sent to client nodes that are not involved in authentication.

In some examples, if client node 1402 receives, from client device 1414, a routing number that is not handled by its location, client node 1402 can return a code indicating that this routing number is not handled, along with validation node address for the responsible validation node. Client device 1414 can then send the full authentication transmission to validation node 1408 using the received validation node address.

In some examples, client node 1402 can enter the distributed network with different permissions. For example, client node 1402 can be a read-only router of data. As another example, client node 1402 can have permission to send messages to distributed ledger node 1410 updating one or more routing paths for one or more routing numbers. However, client node 1402 would be prevented from updating one or more routing paths for one or more routing numbers for other entities that control other routing numbers which are not associated with client node 1402 or that did not grant this permission. As another example, distributed ledger node 1410 can contain contracts and/or records that can validate the permission of a specific entity to change a specific routing record based on its digital signature. As another example, the consortium authority or other administrative entity controlling the distributed network can have additional privileges to, without limitation, add new members (e.g., client nodes, distributed ledger nodes, validation nodes, and/or client devices), add new signature credentials, add new keys, add new certifications, and also to revoke any of the foregoing. In some examples, the foregoing permissions can be delegated to client node 1402, distributed ledger node 1410, and/or validation node 1408, if security, legal, and/or financial conditions are met, however, delegation is not required.

In some examples, one or more APIs can facilitate communication between components of system 1400 via network 1406. In other examples, one or more APIs are not required. Rather, the components of system 1400 could be in direct communication and/or dedicated to one or more specified entities, to allow the specified entities to keep data from being transferred to, transferred from, or transferred via, non-specified entities. This may further promote data security and avoid detection of data traffic patterns by non-specified entities.

In some examples, entities could establish a standard for nodes having APIs based on the intended function of those nodes. For example, a first standard could be established for data routing nodes and a second standard could established for nodes performing mapping and/or authentication functions. As another example, a routing API, a mapping API, and a validation API can be established, which can allow for the same device or hardware configuration to perform these functions. However, the use of keys, including secret keys by validation node 1408 for authentication, can require storage of the keys in one or more HSMs, to promote key security and ensure that the keys are never entered into memory.

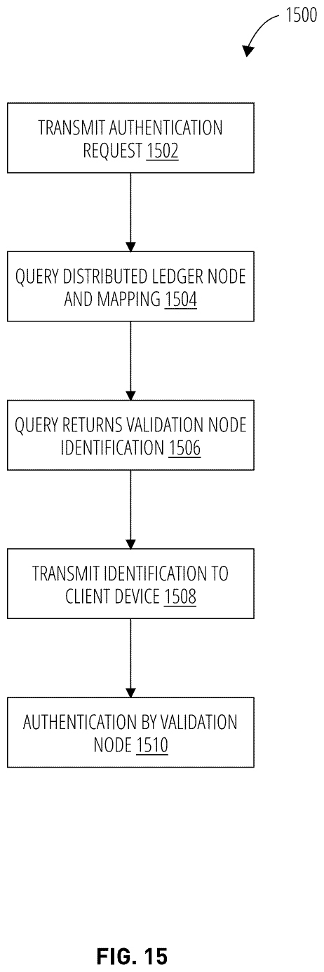

FIG. 15 illustrates a method 1500 performed by a distributed network authentication system according to an example embodiment. For example, the method can be performed by distributed network authentication system 1400 and or by another distributed network authentication system.

In block 1502, a client device can transmit an authentication request to a client node. The authentication request can include, without limitation, a routing number, a software version number, and/or an applet version number. The request can be made by an API call or other communication between the client device and the client node.

In block 1504, after receiving the authentication request, the client node can transmit a query (e.g., via an API call) to a distributed ledger node. The distributed ledger node contain a mapping, and the distributed ledger node can submit the query to the mapping.

In block 1506, the query can return an identification of a validation node and/or a validation node address, and the distributed ledger node can transmit this identification to the client node.

In block 1508, the client node can transmit the identification to the client device. After receiving the identification, the client device can proceed with authentication with the identified validation node and/or validation node address, in block 1510.

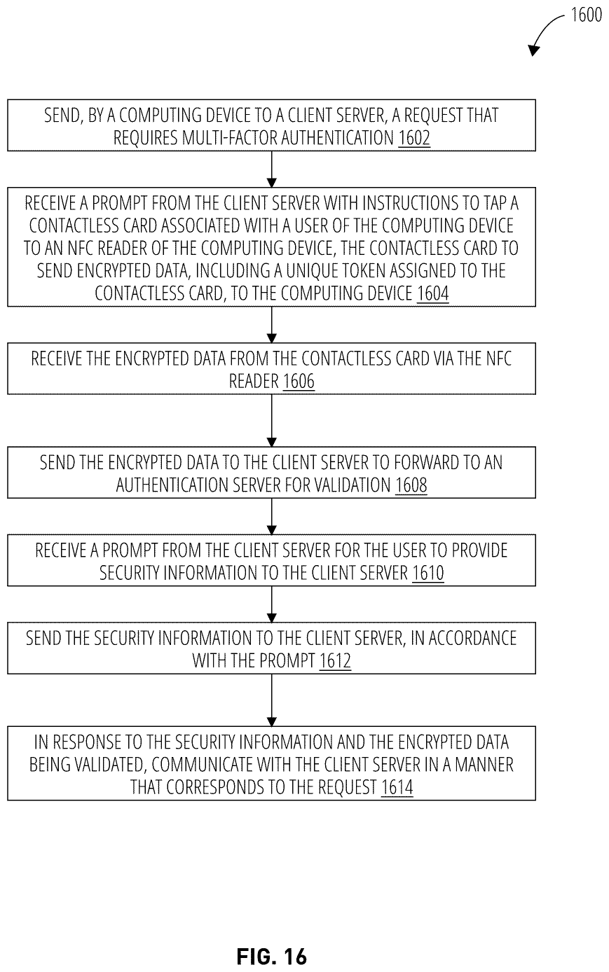

FIG. 16 is a flowchart illustrating various operations performed in a method 1600 according to some embodiments of the present disclosure. As shown at block 1602, the method 1600 includes sending, by a computing device to a client server, a request that requires multi-factor authentication. As shown at block 1604, the method 1600 includes receiving a prompt from the client server with instructions to tap a contactless card associated with a user of the computing device to an NFC reader of the computing device, the contactless card to send encrypted data, including a unique token assigned to the contactless card, to the computing device. As shown at block 1606, the method 1600 includes receiving the encrypted data from the contactless card via the NFC reader.

As shown at block 1608, the method 1600 including sends the encrypted data to the client server to forward to an authentication server for validation. As shown at block 1610, the method 1600 includes receiving a prompt from the client server for the user to provide security information to the client server. As shown at block 1612, the method 1600 includes sending the security information to the client server, in accordance with the prompt. As shown at block 1614, the method 1600 includes in response to the security information and the encrypted data being validated, communicating with the client server in a manner that corresponds to the request.

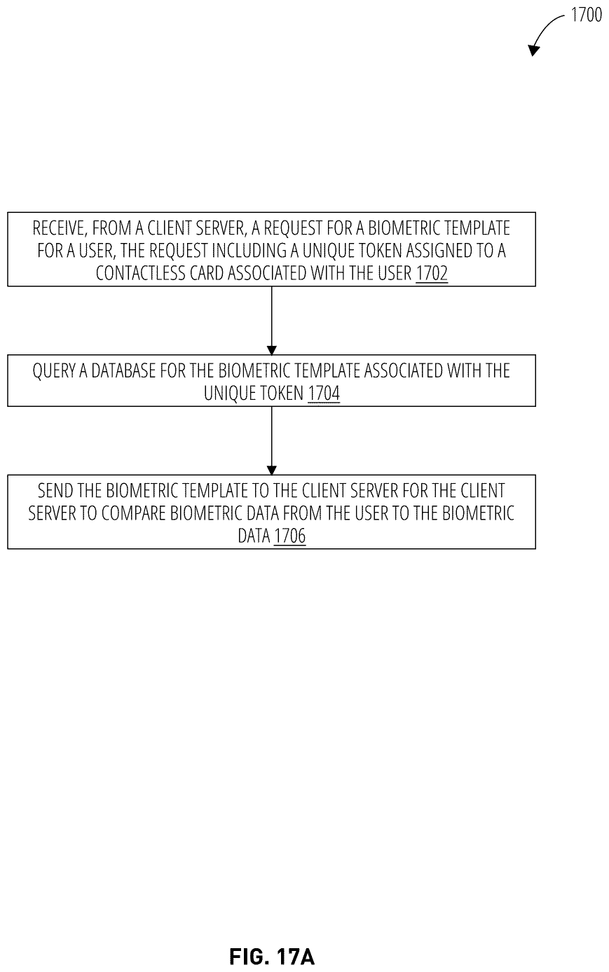

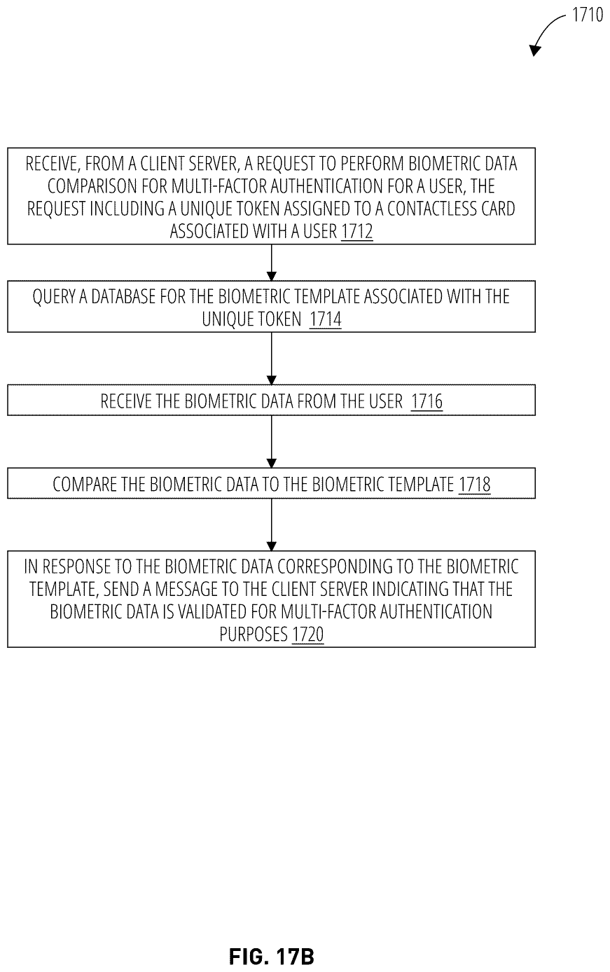

FIG. 17A illustrates another example method 1700 according to other embodiments of the present disclosure. As shown at block 1702, the method 1700 includes receiving, at a domain server from a client server, a request for a biometric template for a user, the request including a unique token assigned to a contactless card associated with the user. As shown at block 1704, the method 1700 includes querying a database for the biometric template associated with the unique token. As shown at block 1706, the method 1700 includes sending the biometric template to the client server for the client server to compare biometric data from the user to the biometric data.

FIG. 17B illustrates another example method 1710 according to other embodiments of the present disclosure. As shown at block 1712, the method 1710 includes receiving, at a domain server from a client server, a request to perform biometric data comparison for multi-factor authentication for a user, the request including a unique token assigned to a contactless card associated with a user. As shown at block 1714, the method 1710 includes querying a database for the biometric template associated with the unique token. As shown at block 1716, the method 1710 includes receiving, at the domain sever, the biometric data from the user. As shown at block 1718, the method 1710 includes comparing, by the domain server, the biometric data to the biometric template. As shown at block 1720, the method 1710 includes, in response to the biometric data corresponding to the biometric template, sending, by the domain server, a message to the client server indicating that the biometric data is validated for multi-factor authentication purposes.

The various elements of the devices as previously described with reference to FIGS. 1-17B may include various hardware elements, software elements, or a combination of both. Examples of hardware elements may include devices, logic devices, components, processors, microprocessors, circuits, processors, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

One or more aspects of at least one embodiment may be implemented by representative instructions stored on a non-transitory machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that make the logic or processor. Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

The foregoing description of example embodiments has been presented for the purposes of illustration and description. It is not intended to be exhaustive or to limit the present disclosure to the precise forms disclosed. Many modifications and variations are possible in light of this disclosure. It is intended that the scope of the present disclosure be limited not by this detailed description, but rather by the claims appended hereto. Future filed applications claiming priority to this application may claim the disclosed subject matter in a different manner, and may generally include any set of one or more limitations as variously disclosed or otherwise demonstrated herein.

What is claimed is:

1. A method comprising:
receiving, at a server from a computing device, a request requiring multi-factor authentication;
causing, by the server, a prompt to be displayed on the computing device for a user of the computing device to tap a contactless card to an NFC reader of the computing device, the contactless card to send encrypted data, including a unique token assigned to the contactless card, to the computing device to forward to an authentication server in communication with the server, the authentication server to validate the encrypted data;
receiving, by the server, at least the unique token from the computing device;
sending, by the server, a request, including the unique token, to a domain server for a security template from the domain server, the security template being associated with a user of the computing device;
receiving, by the server, a validation message from the authentication server indicating that the encrypted data is validated;
receiving, by the server from the domain server, the security template;
prompting, by the server, a user to provide security information for the security template;
receiving, by the server, the security information;
comparing, by the server, the security information to the security template;
in response to the security information matching the security template, granting, by the server, the request.

2. The method of claim 1, wherein the server is a web server hosting a website or a virtual private network (VPN) server configured to establish a VPN and the request is an access request to access the website or a request to establish the VPN.

3. The method of claim 1, wherein the server is a controller or communicates with a controller for controlling access to a physical space, wherein the request is an access request to access the physical space; or
wherein granting the request includes granting, by the server, any request, or performing any other action requested of the server, that requires multi-factor authentication to be performed.

4. The method of claim 1, wherein the server is configured to communicate with the computing device using a computer application operating on the computing device, and wherein causing the prompt to appear on the computing device includes the server to send a message to the computing device via the computer application to display the prompt.

5. The method of claim 1, wherein the security template is a biometric template including a type of biometric feature of the user for the computing device to capture.

6. The method of claim 5, wherein prompting the user to provide the security information to the security template includes sending, by the server, a request to the computing device to provide the security information according to the type of biometric features in the biometric template.

7. The method of claim 6, wherein receiving the security information includes receiving biometric data from the computing device taken of the user, the biometric data taken according to the type of biometric features in the biometric template.

8. The method of claim 5, wherein the biometric features of the user includes at least one of facial features, ocular features, hand or finger features, voice features, and gait features of the user.

9. A server comprising:
a processing circuit; and
a memory coupled to the processing circuit, the memory having executable instructions stored thereon, which when executed by the processing circuit, cause the processing circuit to:
process a request from a computing device, the request requiring multi-factor authentication;
cause a prompt to be displayed to a user, the prompt instructing the user of the computing device to tap a contactless card associated with the user to a near field communication (NFC) reader associated with the computing device;
receive, from the contactless card via the computing device, encrypted data from the contactless card, the encrypted data including a unique token assigned to the contactless card;
forward the encrypted data to an authentication server to validate the encrypted data;
receive an indication from the authentication server that the encrypted data is validated;
send instructions to the computing device to display a request to the user to provide biometric data;
receive the biometric data from the computing device and user and forward the biometric data along with the unique token to a domain server for the domain server to validate the biometric data; and
grant the request from the computing device in response to receiving a first indication from the domain server that the biometric data is validated.

10. The server of claim 9, wherein the processing circuit is further caused to deny the request from the computing device in response to receiving a second indication from the domain server that the biometric data is not validated.

11. The server of claim 9, wherein the request is an access request to access the website or a transaction request to complete a transaction on the server.

12. The server of claim 9, wherein the instructions to the display the request to the user to provide the biometric data includes a type or types of biometric data to be provided by the user.

13. The server of claim 9, wherein validating the biometric data includes identifying a biometric template corresponding to the unique token and comparing the biometric data to the biometric template.

14. The server of claim 9, wherein forwarding the biometric data along with the unique token to the domain server includes the processing circuit being configured to send the biometric data along with the unique token to a switching network server to determine the domain server to which the biometric data and the unique token are to be sent.

15. The server of claim 14, wherein the processing circuit is further caused to receive a validation token from the switching network server validating that the biometric data matches the biometric template corresponding to the unique token, the validation token to be stored in the memory for a predetermined period of time.

16. A switching network server comprising:
a processing circuit; and
a memory having executable instructions stored thereon, which when executed cause the processing circuit to:
receive encrypted data from a contactless card via a computing device in communication with the switching network server, wherein the encrypted data received from the contactless card includes a unique token assigned to the contactless card;
validate the encrypted data and send an authentication message to a transaction server indicating that the encrypted data received from the contactless card is validated;
determine, based on the unique token, a domain server from which to retrieve a biometric template corresponding to the unique token;
send a request to the domain server for the biometric template that corresponds to the unique token and receive the biometric template from the domain server; and
send the biometric template to the transaction server or a biometric reader for the transaction server or the biometric reader to validate biometric data from a user associated with the contactless card and execute a transaction between the contactless card and the transaction server.

17. The switching network server of claim 16, wherein the processing circuit is further configured to generate a validation token associated with the contactless card indicating that the client server has validated the biometric data from the user based on the biometric template, wherein the validation token indicates that the biometric data from the user has been validated recently within a predetermine period of time.

18. The switching network server of claim 17, wherein the processing circuit is further configured to send the validation token to the client server for the client server to store in a memory thereof, wherein the client server is not required to validate the user's biometric data again until after a second predetermined period of time since the validation token was generated.

19. The switching network server of claim 16, wherein the processing circuit is further caused to send the biometric template to the biometric reader, wherein the biometric reader is the computing device in communication with the switching network server.

20. The switching network server of claim 16, wherein the biometric template includes data representing an expected series of biometric data to be received from the user, the biometric data including data related to biometric features of the user including at least one of facial features, ocular features, hand or finger features, voice features, and gait features of the user.
